(19) United States
(12) Patent Application Publication
(10) Pub. No.: US 2015/0284634 A1
(43) Pub. Date: Oct. 8, 2015

(54) NEMATIC LIQUID CRYSTAL COMPOSITION

(71) Applicant: DIC Corporation, Tokyo (JP)

(72) Inventors: Masakazu Kaneoya, Kita-adachi-gun (JP); Kiyofumi Takeuchi, Kita-adachi-gun (JP); Masashi Osawa, Kita-adachi-gun (JP); Kenta Tojo, Kita-adachi-gun (JP); Tetsuo Kusumoto, Kita-adachi-gun (JP)

(73) Assignee: DIC Corporation, Tokyo (JP)

(21) Appl. No.: 14/436,213

(22) PCT Filed: Sep. 5, 2013
(86) PCT No.: PCT/JP2013/073968

§ 371 Date: Jun. 12, 2015

(30) Foreign Application Priority Data
Oct. 17, 2012 (JP) 2012-229813

(51) Int. Cl. C09K 19/34; C09K 19/02; C09K 19/56; C09K 19/54

(52) U.S. Cl. CPC C09K 19/3402; C09K 19/542; C09K 19/0208; C09K 19/0216; C09K 19/56; C09K 2019/3422

(57) ABSTRACT

A liquid crystal composition having positive dielectric anisotropy and sufficiently low viscosity without decreasing refractive index anisotropy or increasing nematic phase-isotropic liquid phase transition temperature, and prevents display failures is provided. The liquid crystal composition comprises one or more compounds selected from compounds represented by general formula (LC0) and one or more compounds selected from the group of compounds represented by general formula (LC1) to general formula (LC5), wherein the liquid crystal composition comprises one or more compounds in which at least one of A²¹ to A⁴² in general formula (LC2) to general formula (LC4) represents a tetrahydropyran-2,5-diyl group.

### TECHNICAL FIELD

The present invention relates to a nematic liquid crystal composition that is useful as an electro-optical liquid crystal display material and has a positive dielectric anisotropy (Δ∈).

### BACKGROUND ART

Liquid crystal display devices are now being increasingly used in watches, calculators, various measuring instruments, automobile panels, word processors, electronic organizers, printers, computers, televisions, clocks, advertising boards, etc. Representative examples of the liquid crystal display modes are TN (twisted nematic) mode, STN (super twisted nematic) mode, and VA (characterized by vertical alignment) mode and IPS (in-plane-switching, characterized by horizontal alignment)/FFS mode that use TFTs (thin film transistors). Liquid crystal compositions used in these liquid crystal display devices are required to be stable against external factors such as moisture, air, heat, and light, be in a liquid crystal phase in a temperature range as wide as possible around room temperature, have low viscosity, and operate at low drive voltage. A liquid crystal composition is made up of several to dozens of compounds in order to optimize the value of dielectric anisotropy (Δ∈) and/or refractive index anisotropy (Δn) or the like for respective display devices.

A vertical alignment mode display uses a liquid crystal composition having a negative Δ∈ while a horizontal alignment mode display, such as a display of a TN mode, STN, mode, or IPS mode, uses a liquid crystal composition having a positive Δ∈. Recently, there has been a report of a drive mode with which a liquid crystal composition having a positive Δ∈ is aligned vertically in the absence of applied voltage and display is performed by applying an IPS/FFS-type electric field, and thus the demand for liquid crystal compositions having positive Δ∈ is increasing. Meanwhile, low-voltage driving, high-speed response, and a wide operation temperature range are desirable in all drive modes. In other words, Δ∈ is required to be positive and have a large absolute value, the viscosity (η) is required to be low, and the nematic phase-isotropic liquid phase transition temperature (Tₙᵢ) is required to be high. Moreover, the Δn of the liquid crystal composition needs to be adjusted to be within an appropriate range in accordance with the cell gap (d) since Δn×d, i.e., the product of Δn and d, is set to a particular level. If a liquid crystal display device is to be used in a television or the like, high-speed response is important and this requires a liquid crystal composition having low γ₁.

There has been disclosed a liquid crystal composition that uses a liquid crystal compound represented by formula (A-1) or (A-2) and having as a positive Δ∈ as a constitutional component (PTL 1 to PTL 4). However, such liquid crystal compositions do not have sufficiently low viscosity.

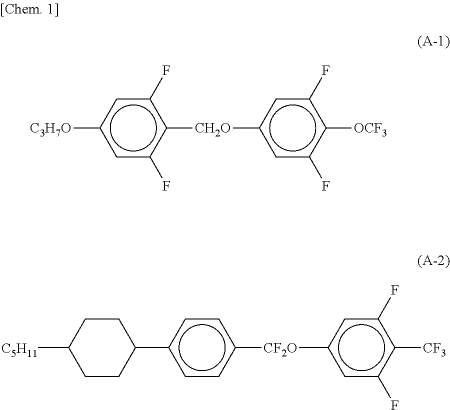

Various skeletons of liquid crystal compounds have also been disclosed. For example, PTL 5 to PTL 19 disclose compounds having tetrahydropyran-2,5-diyl groups and compositions containing such compounds. However, these liquid crystal compositions do not have sufficiently low viscosity.

### CITATION LIST

### Patent Literature

PTL 1: WO96/032365

PTL 2: Japanese Unexamined Patent Application Publication No. 09-157202

PTL 3: WO98/023564

PTL 4: Japanese Unexamined Patent Application Publication No. 2003-183656

PTL 5: Japanese Unexamined Patent Application Publication No. 2005-179676

PTL 6: Japanese Unexamined Patent Application Publication No. 2008-95097

PTL 7: Japanese Unexamined Patent Application Publication No. 2008-95098

PTL 8: Japanese Unexamined Patent Application Publication (Translation of PCT Application) No. 2006-515283

PTL 9: Japanese Unexamined Patent Application Publication (Translation of PCT Application) No. 2008-545669

PTL 10: Japanese Unexamined Patent Application Publication (Translation of PCT Application) No. 2010-500980

PTL 11: Japanese Unexamined Patent Application Publication (Translation of PCT Application) No. 2008-545666

PTL 12: Japanese Unexamined Patent Application Publication No. 2006-328400

PTL 13: Japanese Unexamined Patent Application Publication (Translation of PCT Application) No. 2006-508150

PTL 14: Japanese Unexamined Patent Application Publication (Translation of PCT Application) No. 2007-503485

PTL 15: Japanese Unexamined Patent Application Publication (Translation of PCT Application) No. 2007-506798

PTL 16: Japanese Unexamined Patent Application Publication (Translation of PCT Application) No. 2007-507439

PTL 17: Japanese Unexamined Patent Application Publication No. 2008-163316

PTL 18: Japanese Unexamined Patent Application Publication (Translation of PCT Application) No. 2011-506707

PTL 19: Japanese Unexamined Patent Application Publication (Translation of PCT Application) No. 2011-510112

### SUMMARY OF INVENTION

### Technical Problem

An object of the present invention is to provide a liquid crystal composition that has a positive dielectric anisotropy (Δ∈) and a refractive index anisotropy (Δn) adjusted to a desired level, and sufficiently low viscosity (η) without degrading the nematic phase temperature range since the decrease in nematic phase-isotropic liquid phase transition temperature (Tₙᵢ) and the increase in the nematic phase lower limit temperature are suppressed. Particularly, it is desirable to provide a liquid crystal composition that exhibits a stable nematic phase in a low-temperature zone.

### Solution to Problem

The inventor of the present invention has studied various fluorobenzene derivatives and found that the object described above can be achieved by combining specific compounds. Thus, the present invention has been made.

The present invention provides a liquid crystal composition having positive dielectric anisotropy. The liquid crystal composition contains one or more compounds selected from compounds represented by general formula (LC0) and one or more compounds selected from the group of compounds represented by general formula (LC1) to general formula (LC5), wherein the liquid crystal composition contains one or more compounds in which at least one of A²¹ to A⁴² in general formula (LC2) to general formula (LC4) represents a tetrahydropyran-2,5-diyl group. A liquid crystal display device using the liquid crystal composition is also provided.

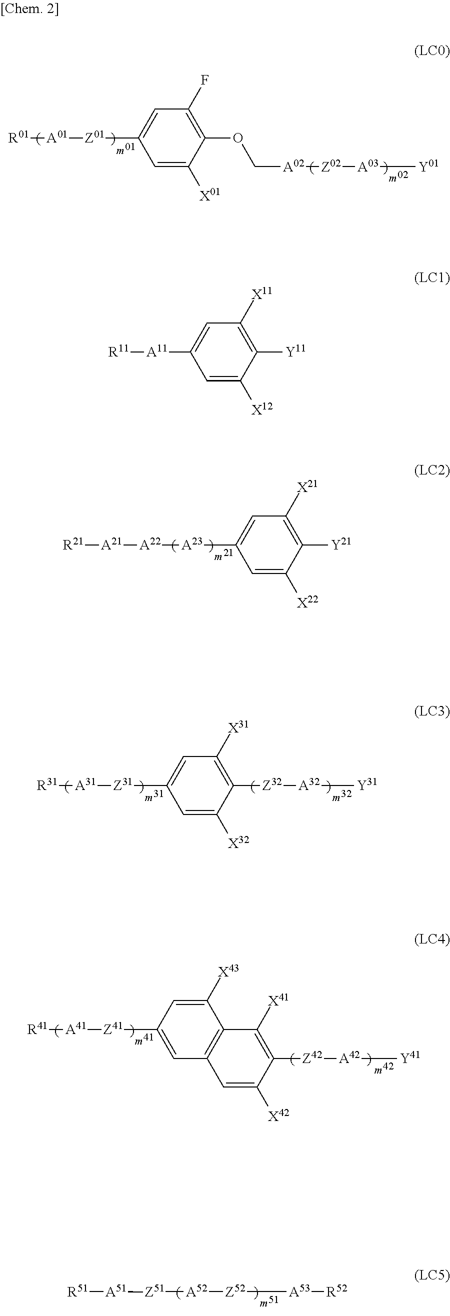

(In the formulae, R⁰¹ to R⁴¹ each independently represent an alkyl group having 1 to 15 carbon atoms where one or more —CH₂— in the alkyl group may each be substituted with —O—, —CH═CH—, —CO—, —OCO—, —COO—, —C≡C—, —CF₂O—, or —OCF₂— so long as oxygen atoms are not directly adjacent to each other and one or more hydrogen atoms in the alkyl group may each be substituted with a halogen; R⁵¹ and R⁵² each independently represent an alkyl group having 1 to 15 carbon atoms where one or more —CH₂— in the alkyl group may each be substituted with —O—, —CH═CH—, —CO—, —OCO—, —COO—, or —C≡C— so long as oxygen atoms are not directly adjacent to each other, and may each represent —OCF₃ or —CF₃— when A⁵¹ or A⁵³ described below represents a cyclohexane ring; A⁰¹ to A⁴² each independently represent any one of the following structures:

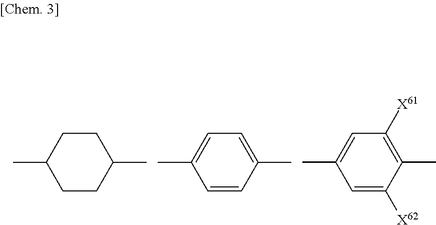

(One or more —CH₂— in a cyclohexane ring in the structure may each be substituted with —O— so long as oxygen atoms are not directly adjacent to each other, one or more —CH═ in a benzene ring in the structure may each be substituted with —N═ so long as nitrogen atoms are not directly adjacent to each other, and X⁶¹ and X⁶² each independently represent —H, —Cl, —F, —CF₃, or —OCF₃.); A⁵¹ to A⁵³ each independently represent any one of the following structures:

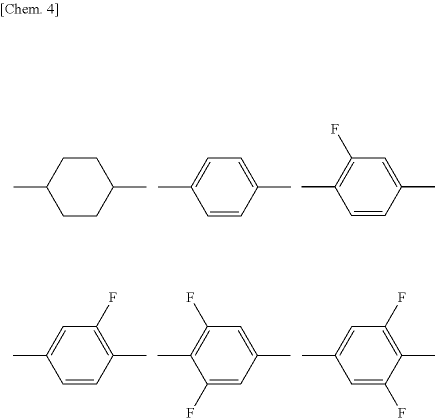

(In the formulae, one or more —CH₂CH₂— in a cyclohexane ring may each be substituted with —CH═CH—, —CF₂O—, or —OCF₂— and one or more —CH═ in a benzene ring may each be substituted with —N═ so long as nitrogen atoms are not directly adjacent to each other); X⁰¹ represents a hydrogen atom or a fluorine atom; X¹¹ to X⁴³ each independently represent —H, —Cl, —F, —CF₃, or —OCF₃; Y⁰¹ to Y⁴¹ each represent —Cl, —F, —OCHF₂, —CF₃, —OCF₃, or a fluorinated alkyl, alkoxy, alkenyl, or alkenyloxy group having 2 to 5 carbon atoms; Z⁰¹ and Z⁰² each independently represent a single bond, —CH═CH—, —C≡C—, —CH₂CH₂—, —(CH₂)₄—, —OCF₂—, or —CF₂O—; Z³¹ to Z⁴² each independently represent a single bond, —CH═CH—, —C≡C—, —CH₂CH₂—, —(CH₂)₄—, —OCF₂—, or —CF₂O— where at least one of Z³¹ and Z³² that are present represents a group other than a single bond; Z⁵¹ and Z⁵² each independently represent a single bond, —CH═CH—, —C≡C—, —CH₂CH₂—, —(CH₂)₄—, —OCH₂—, —CH₂O—, —OCF₂—, or —CF₂O—; m⁰¹ to m⁵¹ each independently represent an integer in the range of 0 to 3, and m⁰¹+m⁰², m³¹+m³², and m⁴¹+m⁴² are each independently 1, 2, 3, or 4; and when a plurality of A⁰¹, A⁰³, A²³, A³¹, A³², A⁴¹, A⁴², A⁵², Z⁰¹, Z⁰², Z³¹, Z³², Z⁴¹, Z⁴², and/or Z⁵² are present, they may be the same or different.)

### Advantageous Effects of Invention

The liquid crystal composition of the present invention is characterized in that the absolute value of Δ∈ can be increased even when Δ∈ is a positive value. Moreover, η is low, rotational viscosity (γ₁) is low, liquid crystal properties are excellent, and a stable liquid phase is exhibited over a wide temperature range. Moreover, the liquid crystal composition is chemically stable against heat, light, water, etc., enables low-voltage driving, and thus is practical and highly reliable.

### DESCRIPTION OF EMBODIMENTS

A liquid crystal composition according to the invention of the subject application contains one or more compounds selected from compounds represented by general formula (LC0) and one or more compounds selected from the group of compounds represented by general formula (LC1) to general formula (LC5). Since a liquid crystal composition that contains a compound represented by general formula (LC0) and compounds represented by general formula (LC1) to general formula (LC5) is in a stable liquid crystal phase even at low temperature, the liquid crystal composition can be considered as practical.

In general formula (LC0) to general formula (LC5), R⁰¹ to R⁵² preferably each independently represent an alkyl group having 1 to 8 carbon atoms, an alkenyl group having 2 to 8 carbon atoms, or an alkoxy group having 1 to 8 carbon atoms, and are preferably each linear. When R⁰¹ to R⁵² represent alkenyl groups, the alkenyl groups are preferably selected from groups represented by formula (R1) to formula (R5):

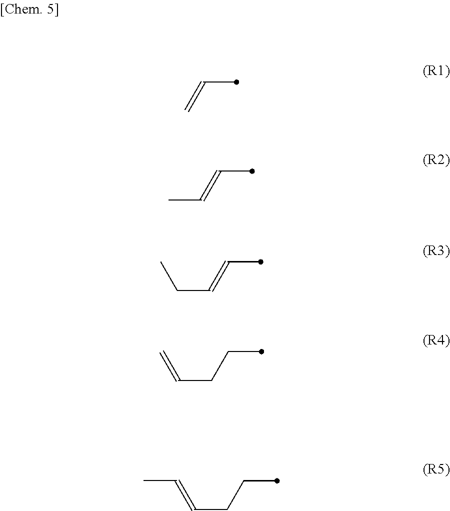

(In each formula, black dot indicates a bonding point to a ring.)
In the case where A⁰¹, A¹¹, A²¹, A³¹, A⁴¹, A⁵¹, and A⁵³ each represent a trans-1,4-cyclohexylene group, these groups are are preferred and the groups represented by formula (R1), formula (R2), and formula (R4) are more preferred. The liquid crystal composition yet more preferably contains at least one compound represented by general formula (LC5) with at least one of R⁵¹ and R⁵² representing an alkenyl group selected from those represented by formula (R1) to formula (R5).

A⁰¹ to A⁴² each independently represent a trans-1,4-cyclohexylene group, a 1,4-phenylene group, a 3-fluoro-1,4-phenylene group, a 3,5-difluoro-1,4-phenylene group, or a tetrahydropyran-2,5-diyl group. In the case where some of A⁰¹ to A⁴² represent tetrahydropyran groups, those some groups are preferably A⁰¹, A¹¹, A²¹, and A³¹. Specific examples of preferable compounds having tetrahydropyran-2,5-diyl groups include those represented by general formula (LC0-7) to general formula (LC0-9), general formula (LC0-23), general formula (LC0-24), general formula (LC0-26), general formula (LC0-27), general formula (LC0-20), general formula (LC0-40), general formula (LC0-51) to general formula (LC0-53), general formula (LC0-110), general formula (LC0-111), general formula (LC2-9) to general formula (LC2-14), general formula (LC3-23) to general formula (LC3-32), general formula (LC4-12) to general formula (LC4-14), general formula (LC4-16), general formula (LC4-19), and general formula (LC4-22) described below. It is preferable for achieving the object of the present invention to contain one or more compounds selected from the group consisting of these compounds.

A⁵¹ to A⁵³ preferably each independently represent a trans-1,4-cyclohexylene group, a 1,4-phenylene group, a 3-fluoro-1,4-phenylene group, or a 2-fluoro-1,4-phenylene group.

Z⁰¹ and Z⁰² preferably each independently represent a single bond, —CH═CH—, —C≡C—, —CH₂CH₂—, —OCF₂—, or —CF₂O—. When one of Z⁰¹ and Z⁰² that are present represents —CH═CH—, —C≡C—, —CH₂CH₂—, —(CH₂)₄—, —OCF₂—, or —CF₂O—, the other preferably represents a single bond; more preferably, both Z⁰¹ and Z⁰² represent single bonds.

Z³¹ to Z⁴² preferably each independently represent a single bond, —CH═CH—, —C≡C—, —CH₂CH₂—, —OCH₂—, —CH₂—, —OCF₂—, or —CF₂O—. When one of Z³¹ to Z⁴² that are present represents —CH═CH—, —C≡C—, —CH₂CH₂—, —(CH₂)₄—, —OCF₂—, or —CF₂O—, others preferably represent single bonds.

Z⁵¹ and Z⁵² preferably each independently represent a single bond, —CH═CH—, —C≡C—, —CH₂CH₂—, —OCF₂—, or —CF₂O—. When one of Z⁵¹ and Z⁵² that are present represents —CH═CH—, —C≡C—, —CH₂CH₂—, —(CH₂)₄—, —OCH₂—, —CH₂O—, —OCF₂—, or —CF₂O—, the other preferably represents a single bond; more preferably, both Z⁵¹ and Z⁵² represent single bonds.

X⁰¹ particularly preferably represents F since a notably low viscosity (η) is achieved relative to a high dielectric anisotropy (Δ∈) or the same level of dielectric anisotropy (Δ∈).

X¹¹ to X⁴³ preferably each independently represent H or F. X¹¹, X²¹, X³¹, and X⁴¹ preferably each represent F.

Y⁰¹ to Y⁴¹ preferably each independently represent F, CF₃, or OCF₃.

Although m⁰¹ to m⁵¹ can each independently represent an integer in the range of 0 to 3, m⁰¹+m⁰² is more preferably 1 or 2, m²¹ is more preferably 0, m³¹+m³² is more preferably 1, 2, or 3, and m⁴¹+m⁴² is more preferably 1 or 2.

A liquid crystal compound represented by general formula (LC0) is more preferably any of compounds represented by general formulae (LC0-a) to (LC0-h) below (where R⁰¹, A⁰¹, A⁰², A⁰³, Z⁰¹, Z⁰², X⁰¹, and Y⁰¹ are the same as those in general formula (LC0) and when two or more A⁰¹, A⁰³, and/or Z⁰¹, Z⁰² are present, they may be the same or different).

The compound represented by general formula (LC0) in the liquid crystal composition of the present invention is preferably any of compounds represented by (LC0-a) to (LC0-h).

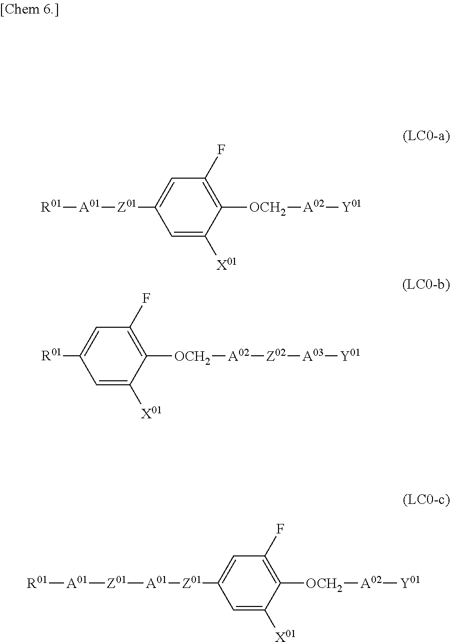

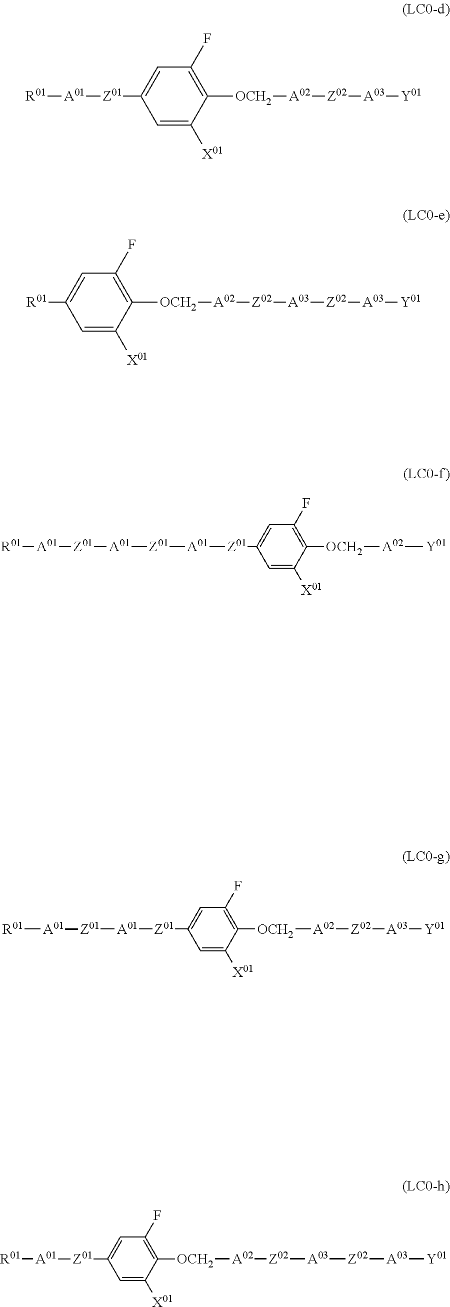

More preferable are the compounds represented by general formula (LC0-1) to general formula (LC0-111) below:

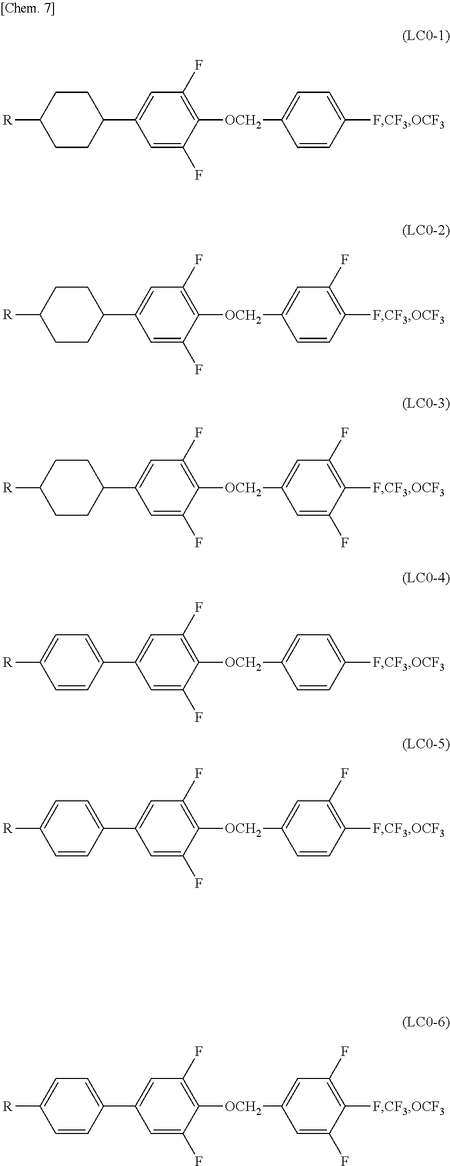

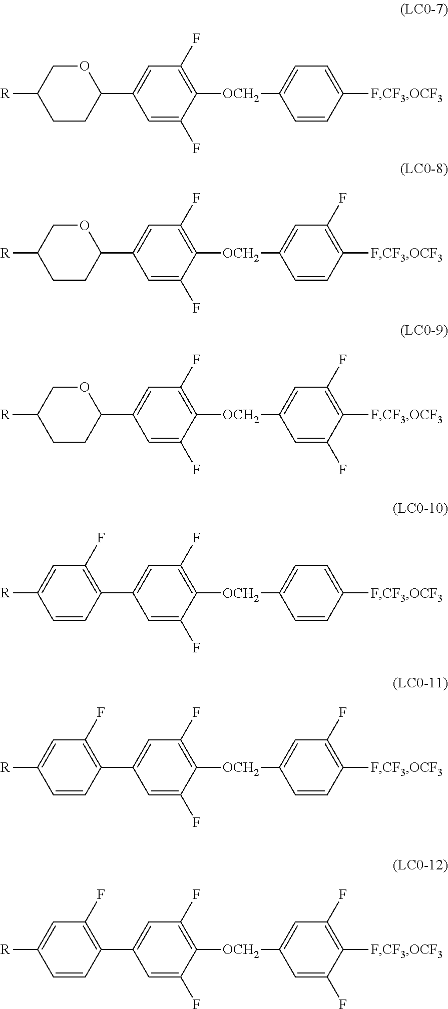

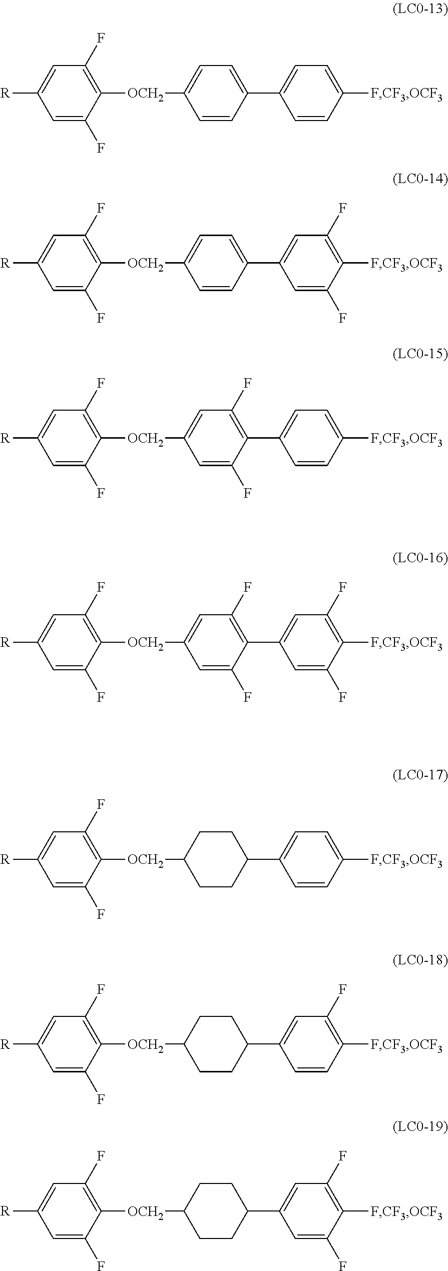

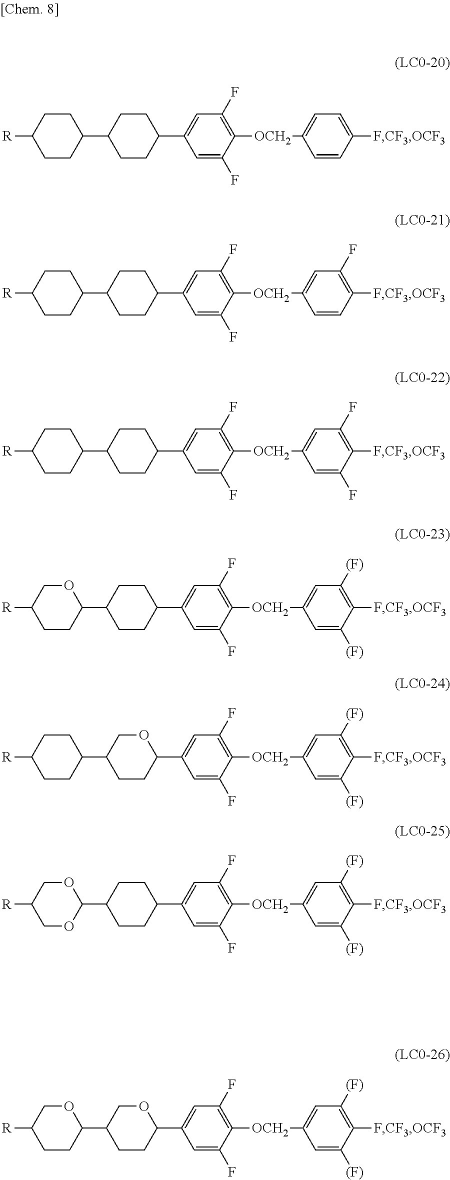

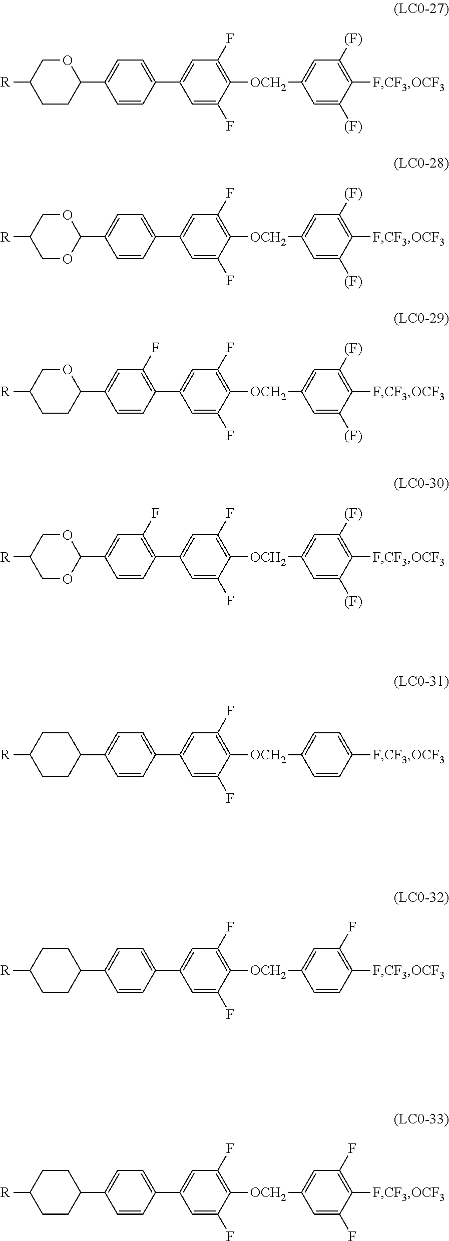

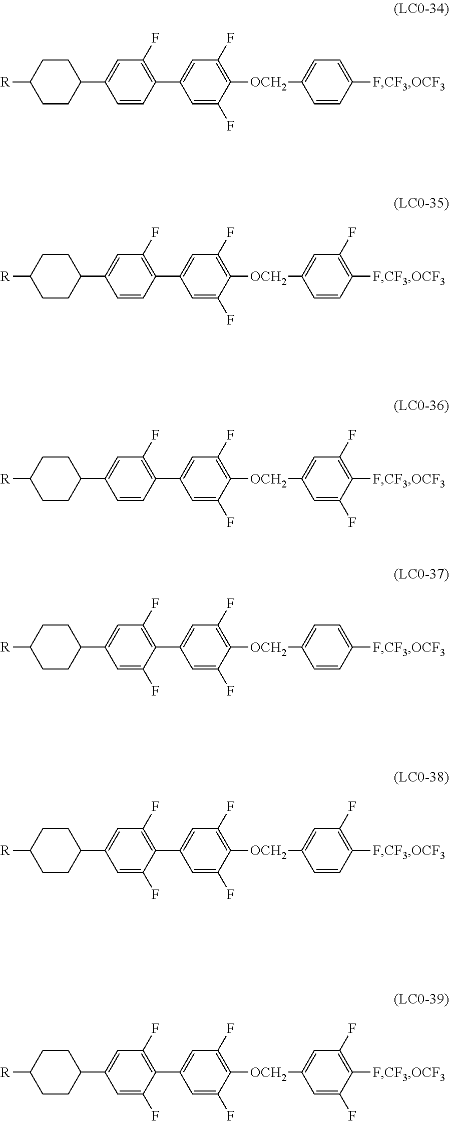

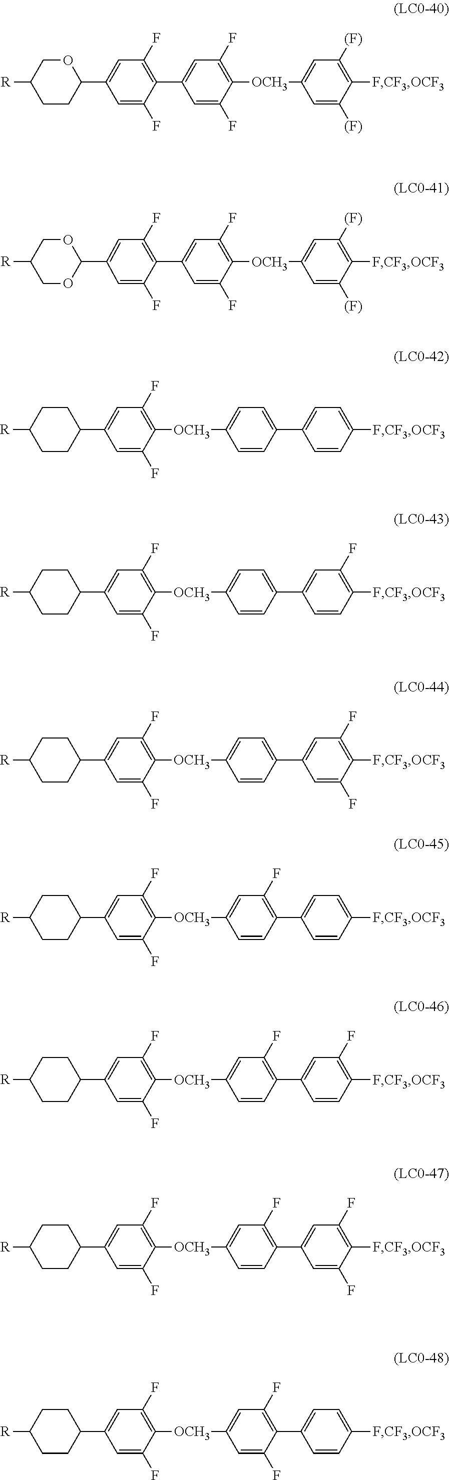

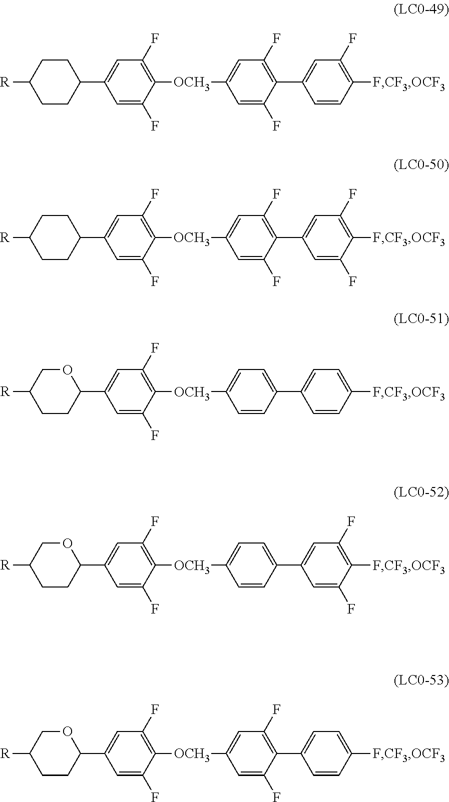

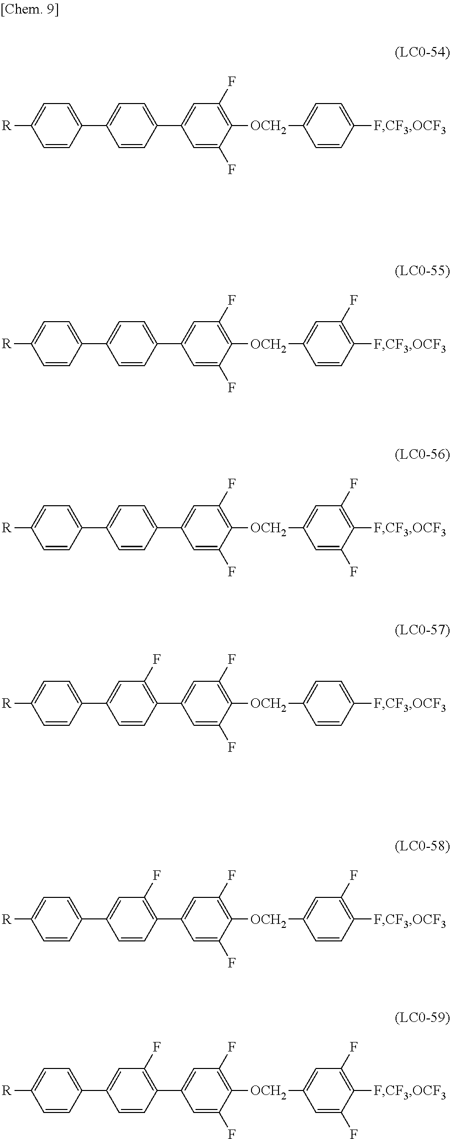

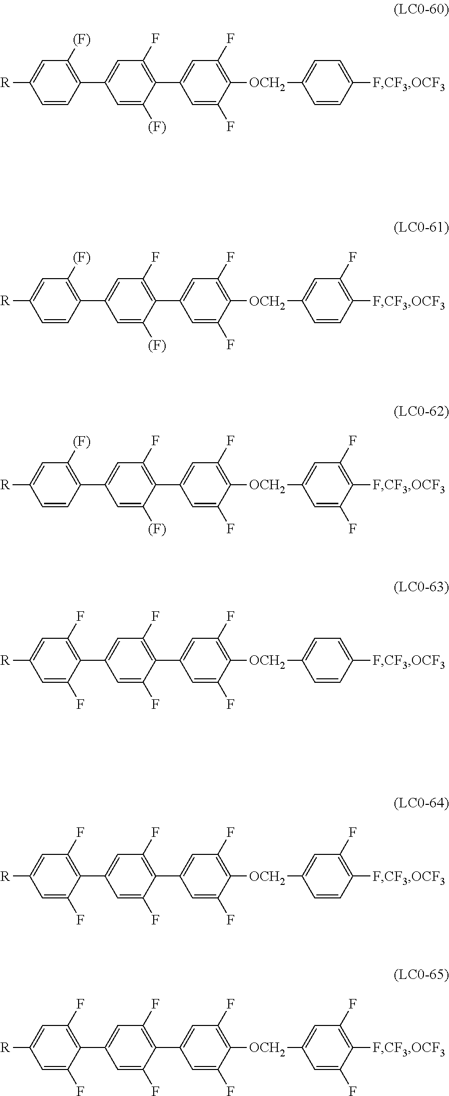

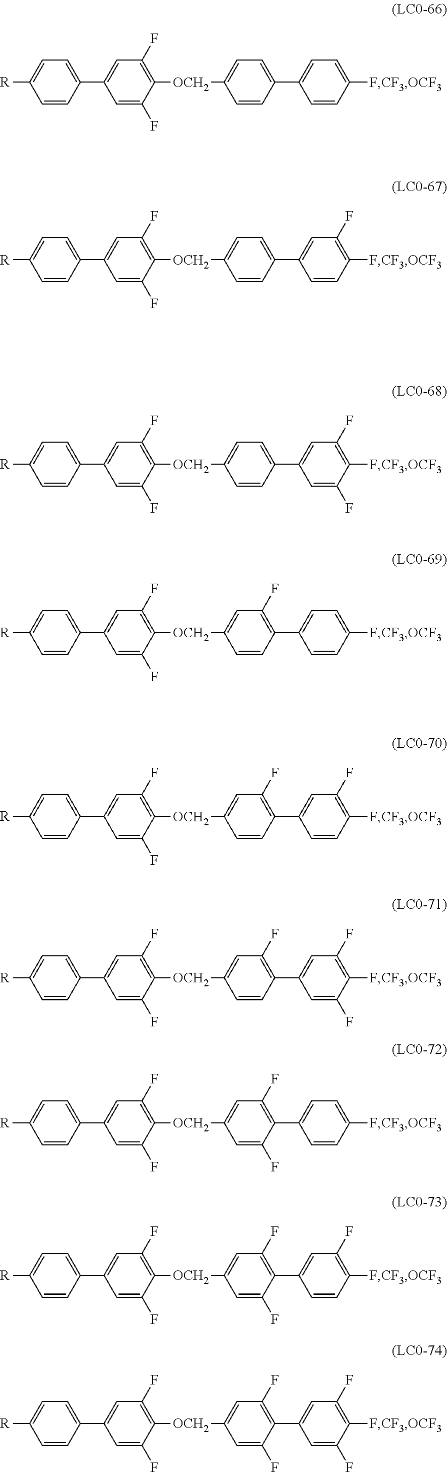

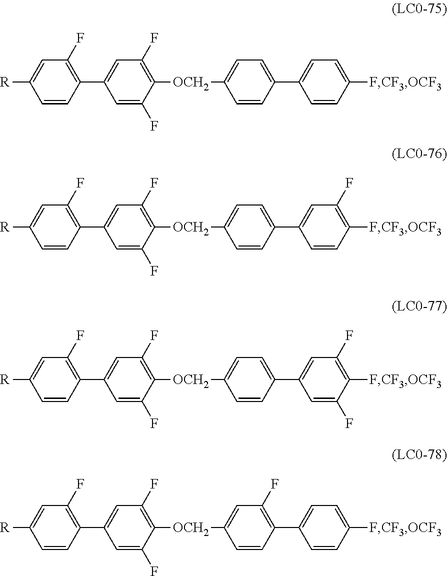

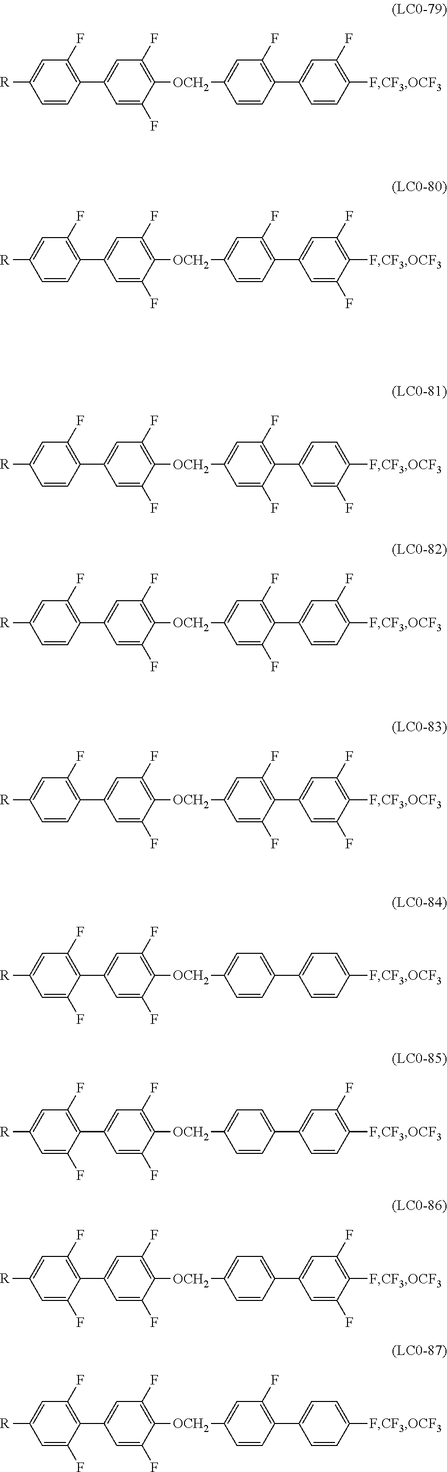

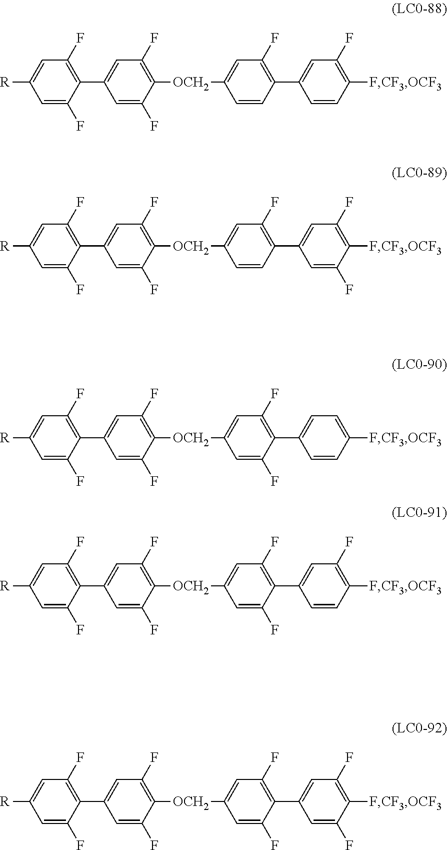

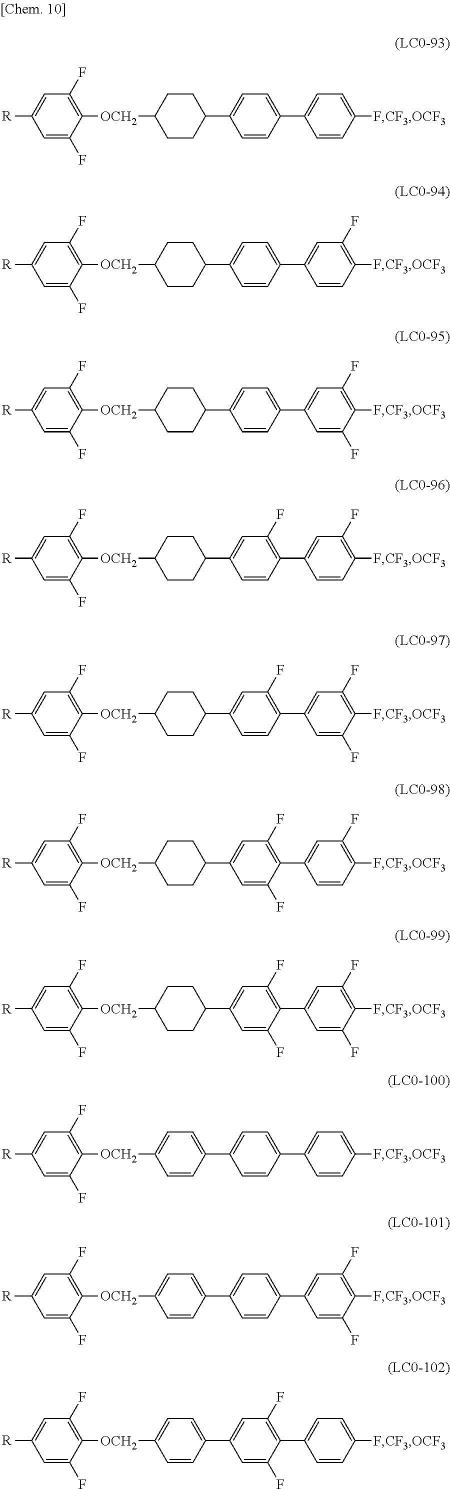

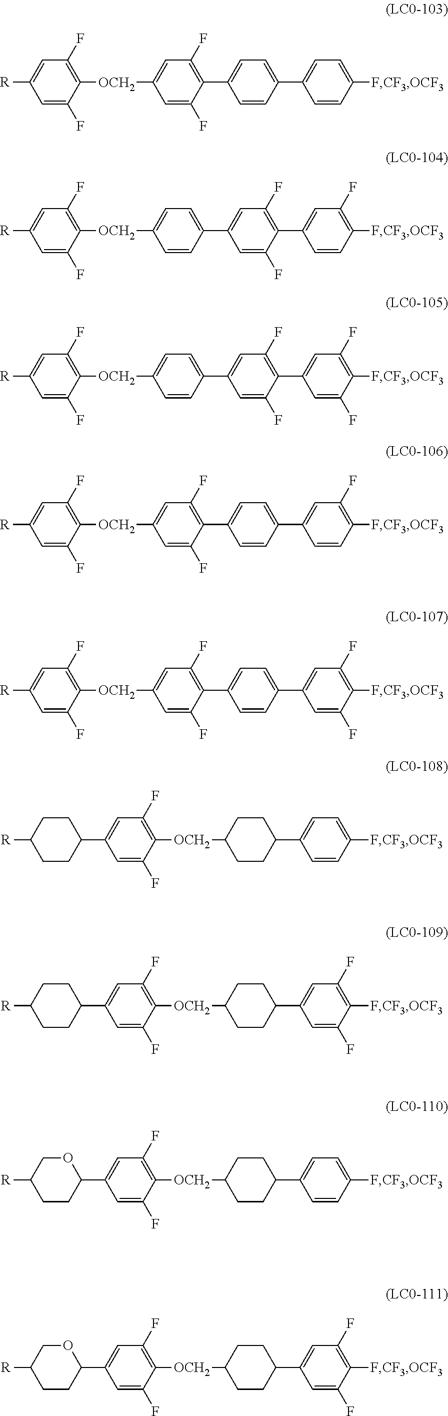

(In the formulae, R is the same as R⁰¹ in general formula (LC0), “—F, CF₃, OCF₃” each independently represent —F, CF₃, or OCF₃, and (—F) represents H or F as a substituent.) Compounds represented by general formula (LC0-1) to general formula (LC0-19) are particularly preferable since they have high dielectric anisotropy (Δ∈), notably low viscosity (1), and favorable compatibility at the same time. Compounds represented by general formula (LC0-20) to general formula (LC0-111) are particularly preferable since they have high dielectric anisotropy (Δ∈), relatively low viscosity (η), and high nematic phase-isotropic liquid phase transition temperature (Tₙᵢ) at the same time.

The compound represented by general formula (LC2) is preferably any of the compounds represented by general formula (LC2-1) to general formula (LC2-17) below:

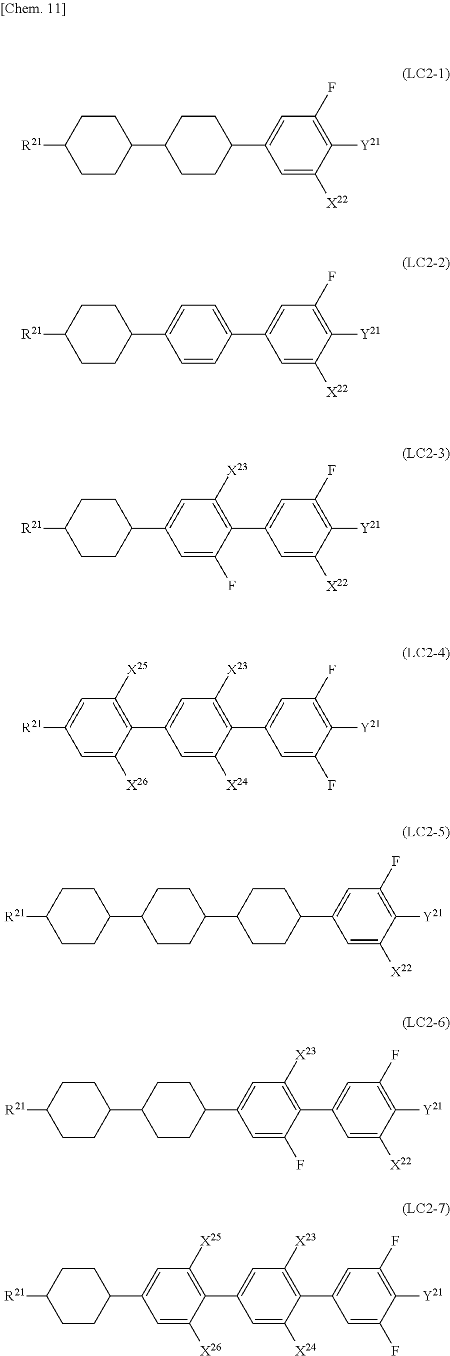

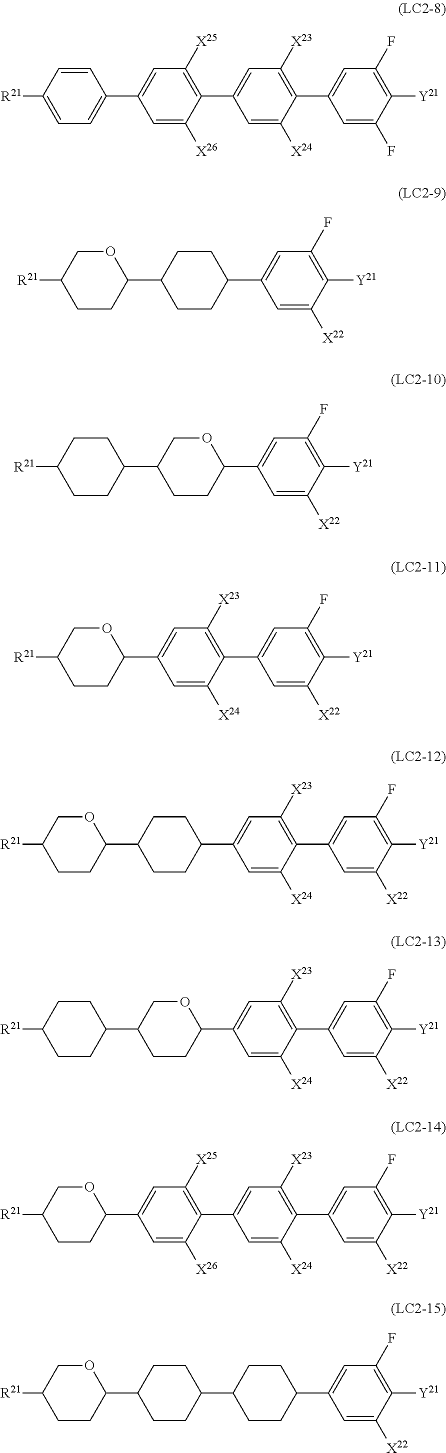

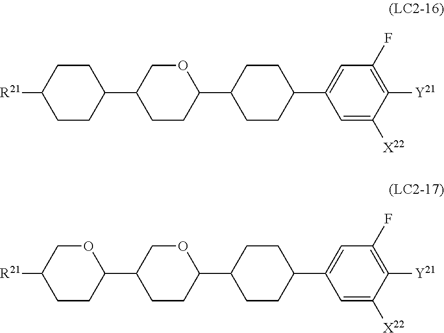

(In the formulae, X²³, X²⁴, X²⁵, and X²⁶ each independently represent a hydrogen atom, Cl, F, CF₃, or OCF₃, and X²², R²¹, and Y²¹ are the same as those in general formula (LC2).) The group of compounds represented by general formula (LC2-1) to general formula (LC2-4) and general formula (LC2-9) to general formula (LC2-11) is yet more preferable.

The compound having a tetrahydropyran-2,5-diyl group represented by general formula (LC2) is preferably any of compounds represented by general formula (LC2-9) to general formula (LC2-17). The compounds represented by general formula (LC2-9) to general formula (LC2-12) and general formula (LC2-14) are more preferable.

The compound represented by general formula (LC3) is preferably any of compounds represented by general formula (LC3-1) to general formula (LC3-41) below:

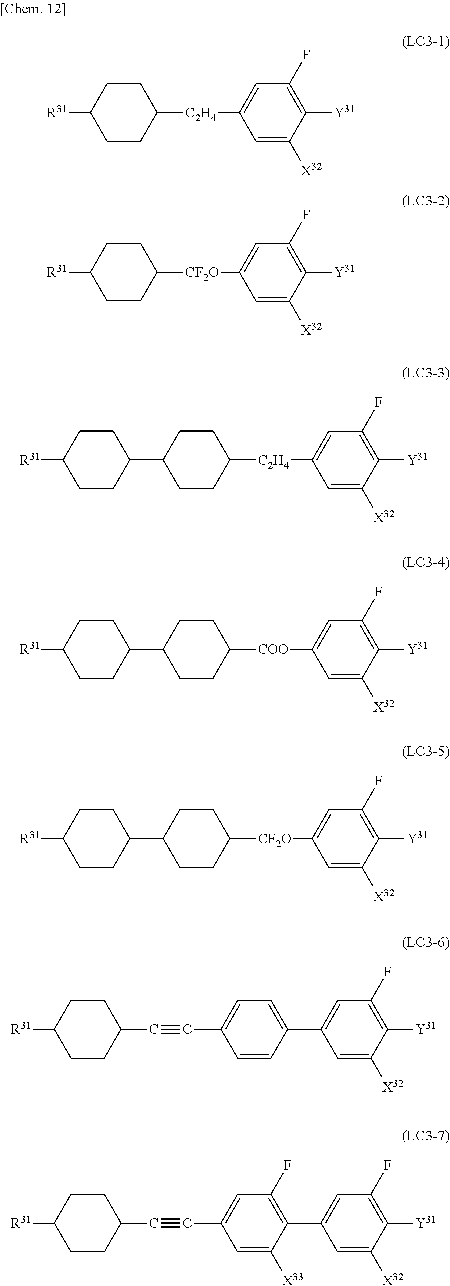

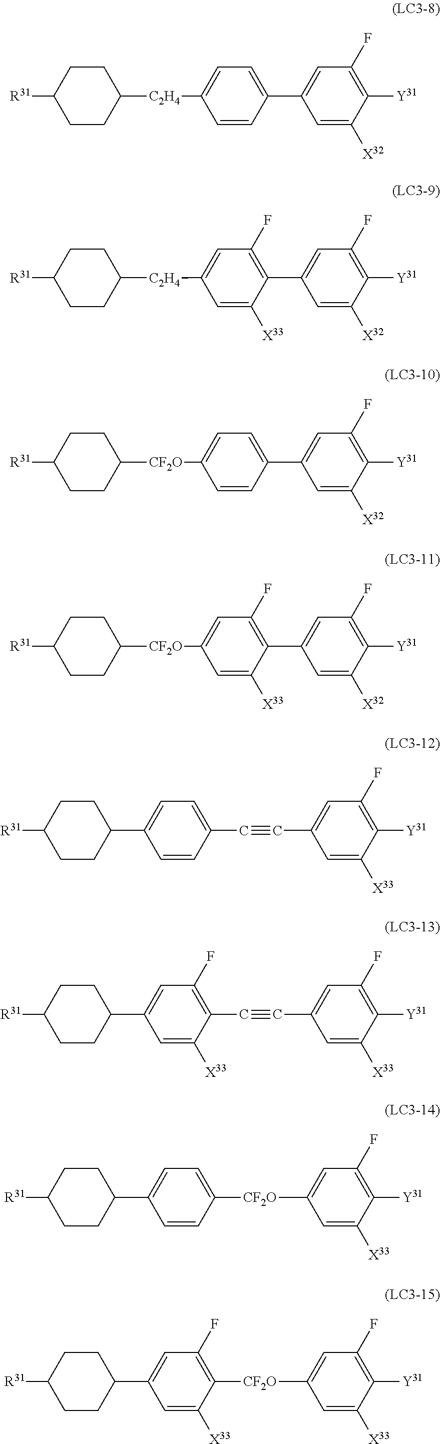

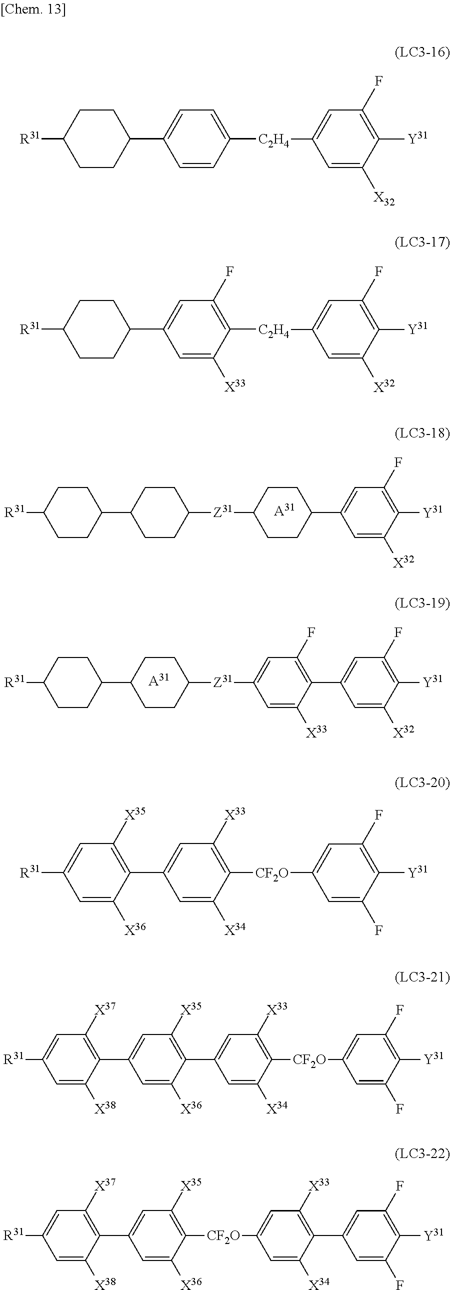

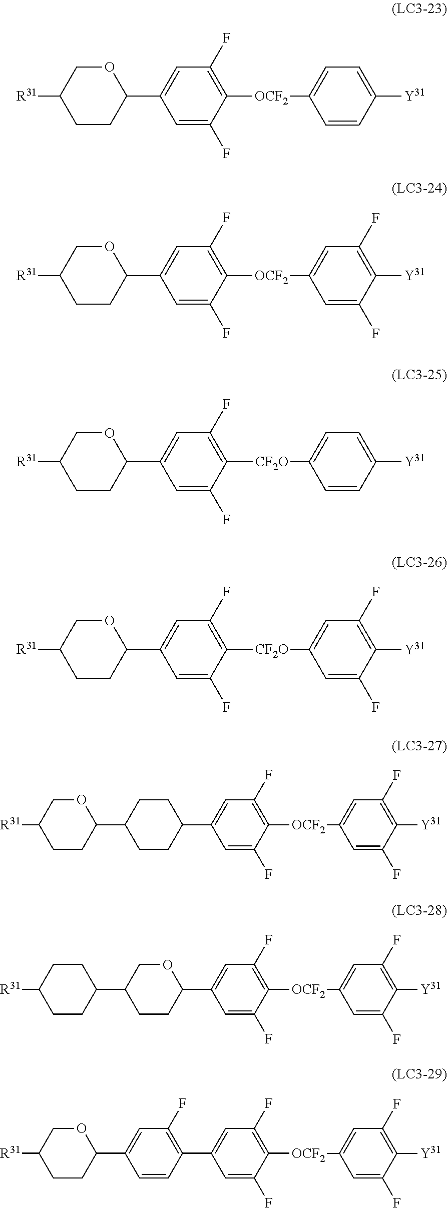

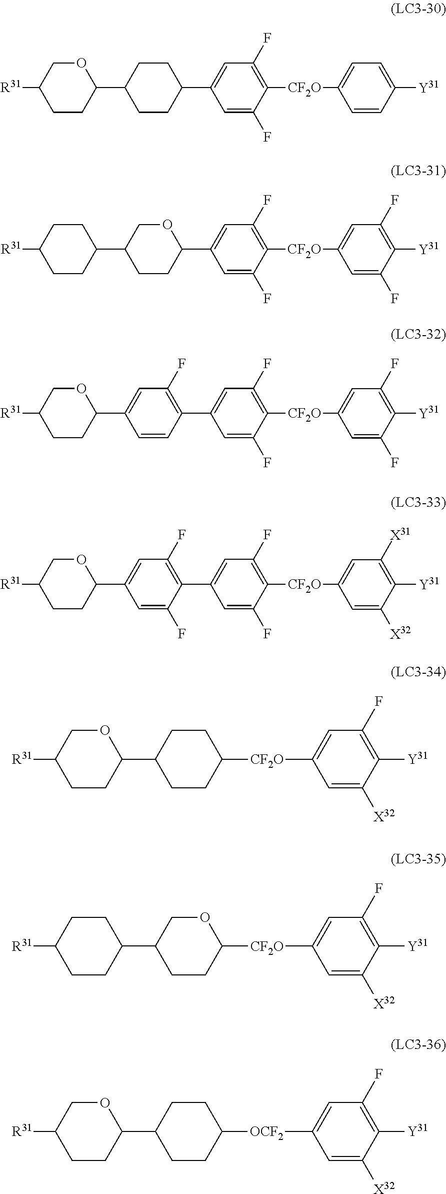

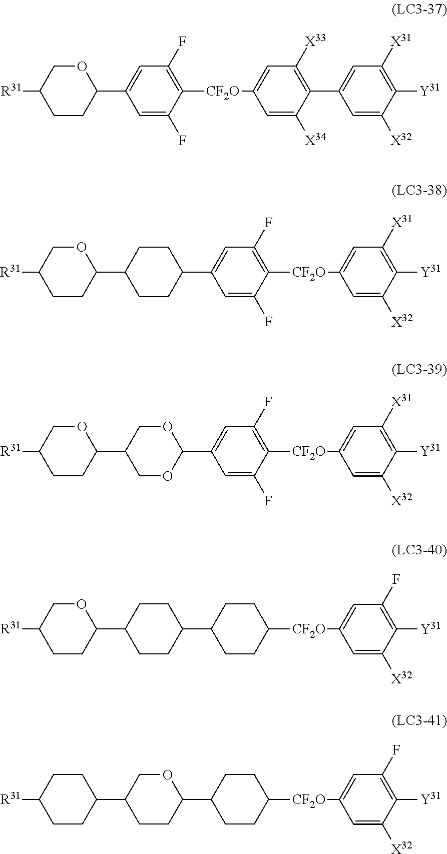

(In the formulae, X³³, X³⁴, X³⁵, X³⁶, X³⁷, and X³⁸ each independently represent H, Cl, F, CF₃, or OCF₃, and X³², R³¹, A³¹, Y³¹, and Z³¹ are the same as those in general formula (LC3).) Of these, the group of compounds represented by general formula (LC3-5), general formula (LC3-15), and general formula (LC3-20) to general formula (LC3-32) is more preferably used in combination with an essential component of the present invention represented by general formula (LC0). More preferably, a compound selected from the group of compounds represented by general formula (LC3-20) and general formula (LC3-21) with X³³ and X³⁴ representing F and/or the group of compounds represented by general formula (LC3-25), general formula (LC3-26), and general formula (LC3-30) to general formula (LC3-32) is used in combination with an essential component of the present invention represented by general formula (LC0).

The compound having a tetrahydropyran-2,5-diyl group represented by general formula (LC3) is preferably any of compounds represented by general formula (LC3-23) to general formula (LC3-41). The content thereof is preferably 5 to 35% relative to the total of the liquid crystal composition.

The compound represented by general formula (LC4) is preferably any of compounds represented by general formula (LC4-1) to general formula (LC4-23) below:

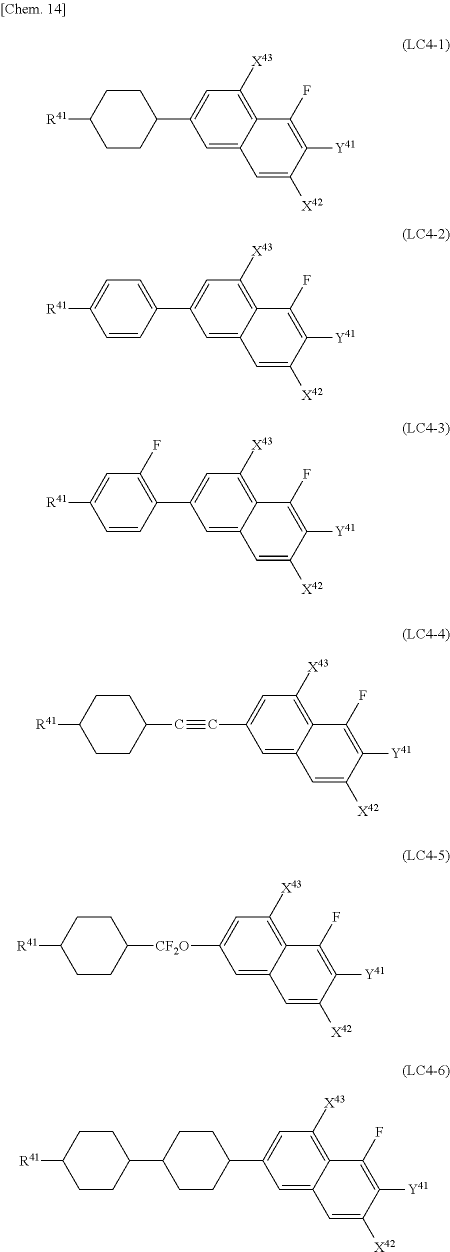

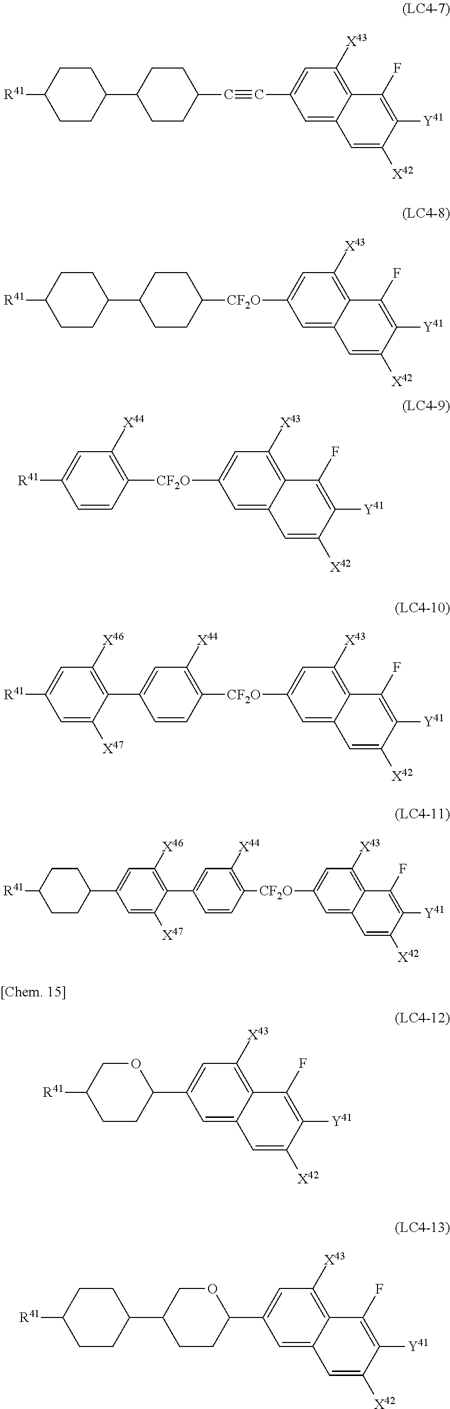

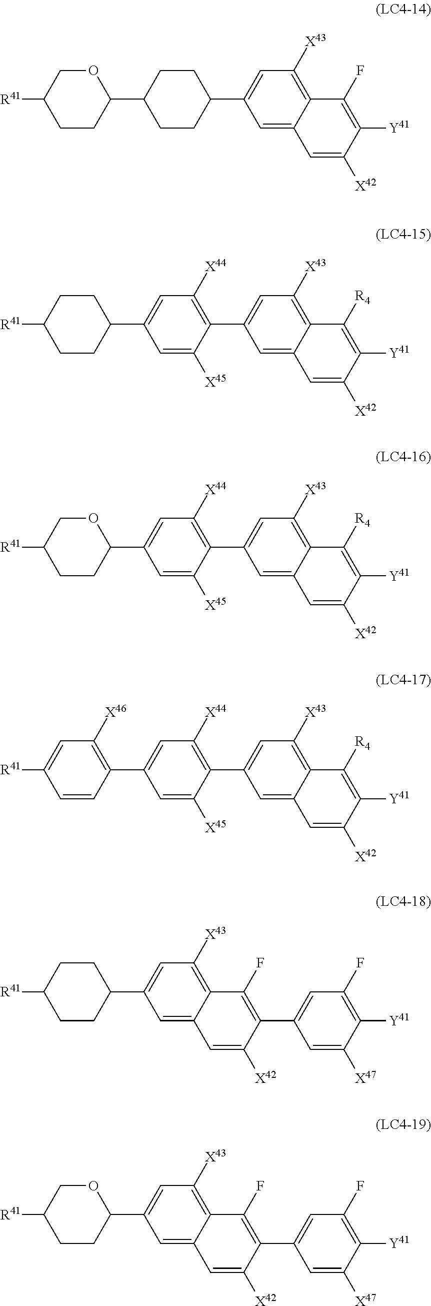

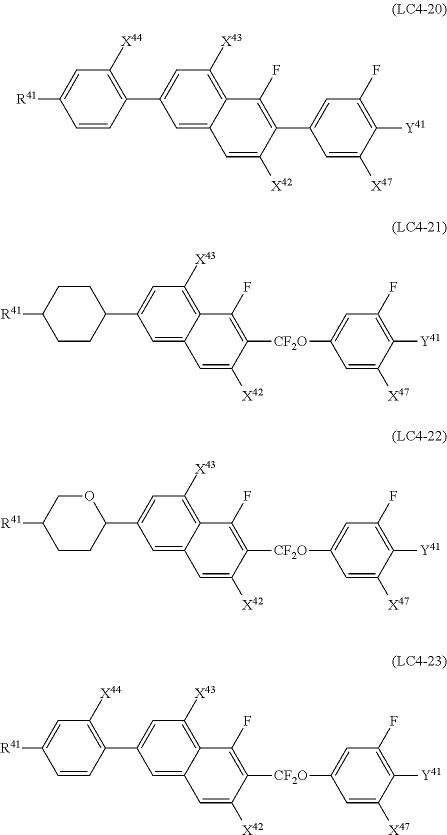

(In the formulae, X⁴⁴, X⁴⁵, X⁴⁶, and X⁴⁷ each independently represent H, Cl, F, CF₃, or OCF₃, and X⁴², X⁴³, R⁴¹, and Y⁴¹ are the same as those in general formula (LC4).) Among these, the group of compounds represented by general formula (LC4-1) to general formula (LC4-3), general formula (LC4-6), general formula (LC4-9), general formula (LC4-10), and general formula (LC4-12) to general formula (LC4-17) is more preferably used in combination with an essential component of the present invention represented by general formula (LC0). Most preferably, a compound selected from the group of compounds represented by general formula (LC4-9) to general formula (LC4-11) and general formula (LC4-15) to general formula (LC4-17) with X⁴⁴ and/or X⁴⁵ representing F is used in combination with an essential component of the present invention represented by general formula (LC0).

The compound represented by general formula (LC5) is preferably any of the following compounds represented by general formula (LC5-1) to general formula (LC5-26):

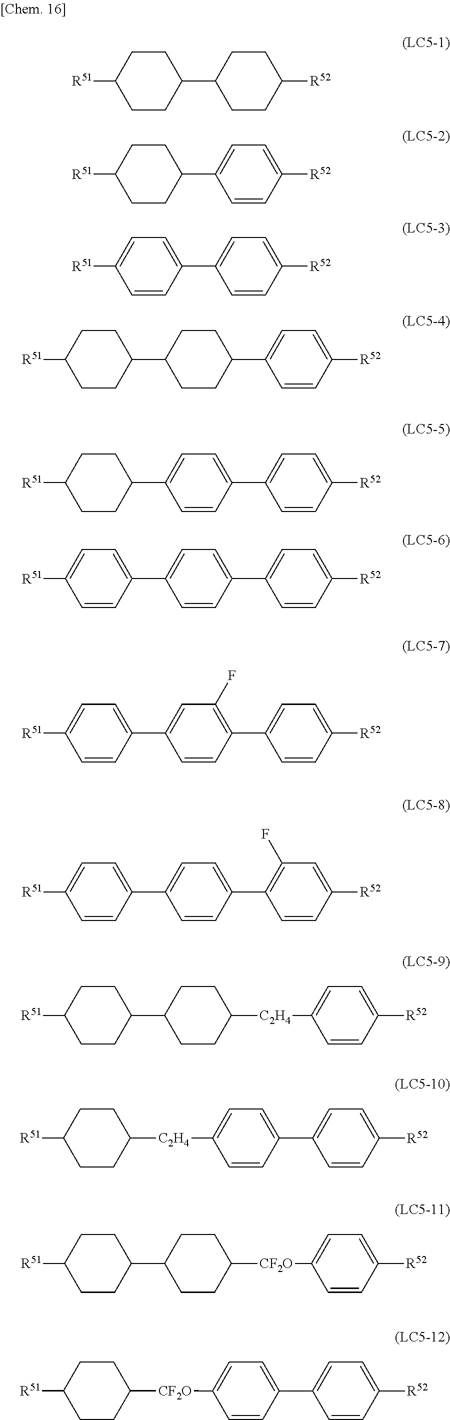

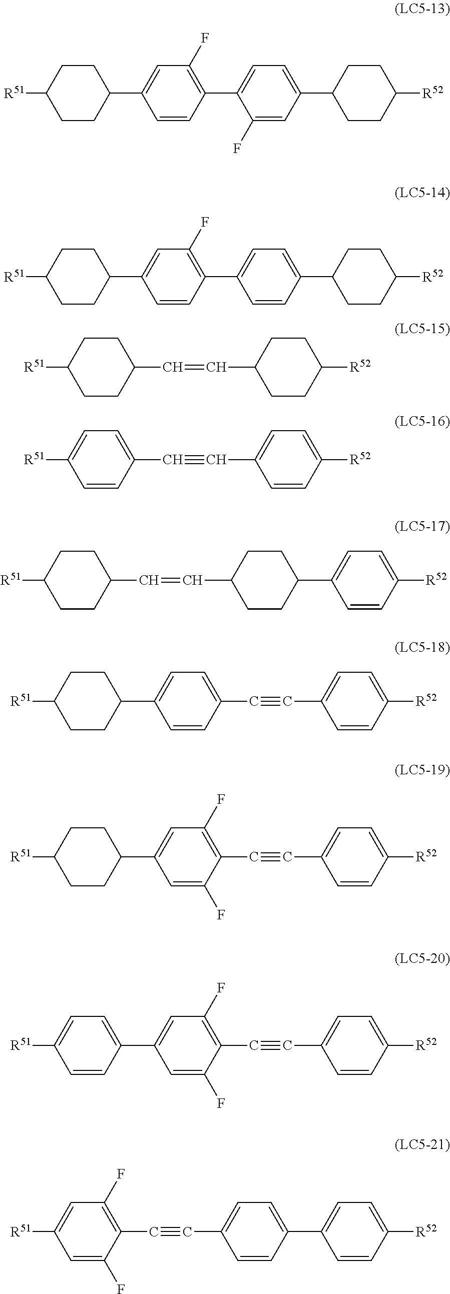

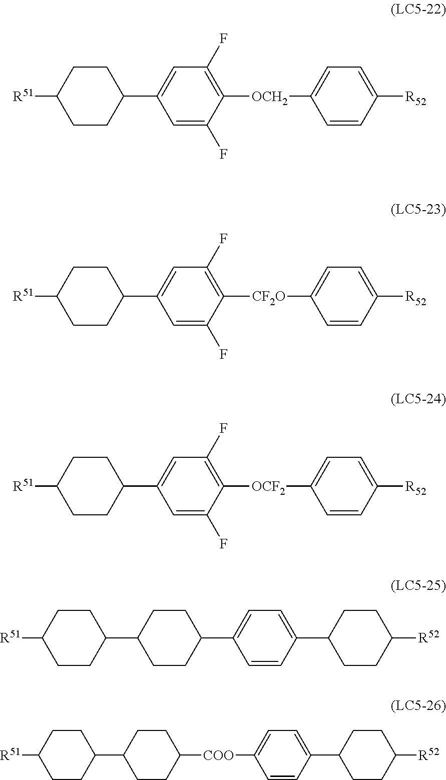

(In the formulae, R⁵¹ and R⁵² are the same as those in general formula (LC5).) Of these, the group of compounds represented by general formula (LC5-1) to general formula (LC5-8), general formula (LC5-14), general formula (LC5-16), and general formula (LC5-18) to general formula (LC5-26) is more preferably used in combination with an essential component of the present invention represented by general formula (LC0). The group of compounds represented by general formula (LC5-1) and general formula (LC5-4) with at least one of R⁵¹ and R⁵² representing an alkenyl group, where the alkenyl group is particularly preferably one of formulae (R1) to (R5) below, is yet more preferable.

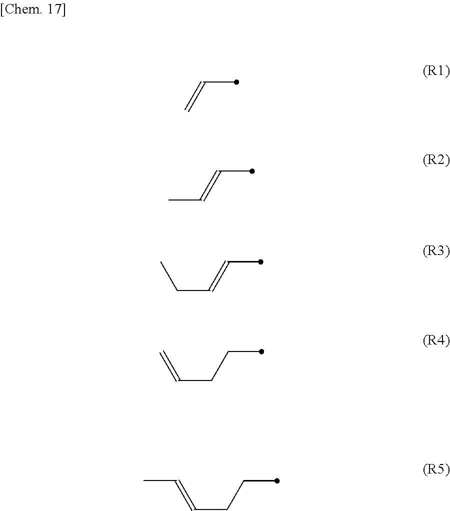

Preferably, one or more compounds represented by general formula (LC5) are contained and the content thereof is preferably 20 to 70% by mass and more preferably 30 to 70% by mass.

The liquid crystal composition of the present invention contains a compound represented by general formula (LC0) and a compound selected from the group of compounds represented by general formula (LC1) to general formula (LC5), in which the liquid crystal composition contains at least one compound having a tetrahydropyran-2,5-diyl group selected from those represented by general formula (LC2) to general formula (LC4). More preferably, the liquid crystal composition contains at least one compound having a tetrahydropyran-2,5-diyl group selected from compounds represented by general formula (LC2) and general formula (LC3).

The content of the compound having a tetrahydropyran-2,5-diyl group is preferably in the range of 5 to 50% by mass and more preferably in the range of 10 to 40% by mass.

The liquid crystal composition of the present invention preferably has a viscosity 1 of 20 mPa·s or less at 20° C.

The liquid crystal composition of the present invention can contain one or more optically active compounds. Any optically active compound that can twist and align liquid crystal molecules can be used. Since twisting usually changes with temperature, a plurality of optically active compounds can be used in order to obtain desired temperature dependency. It is preferable to select and use an optically active compound having a powerful twisting effect in order not to adversely affect the nematic liquid crystal phase temperature range, viscosity, and the like. Preferable specific examples of the optically active compound include liquid crystals such as cholesteric nonanoate and compounds represented by general formula (Ch-1) to general formula (Ch-6) below:

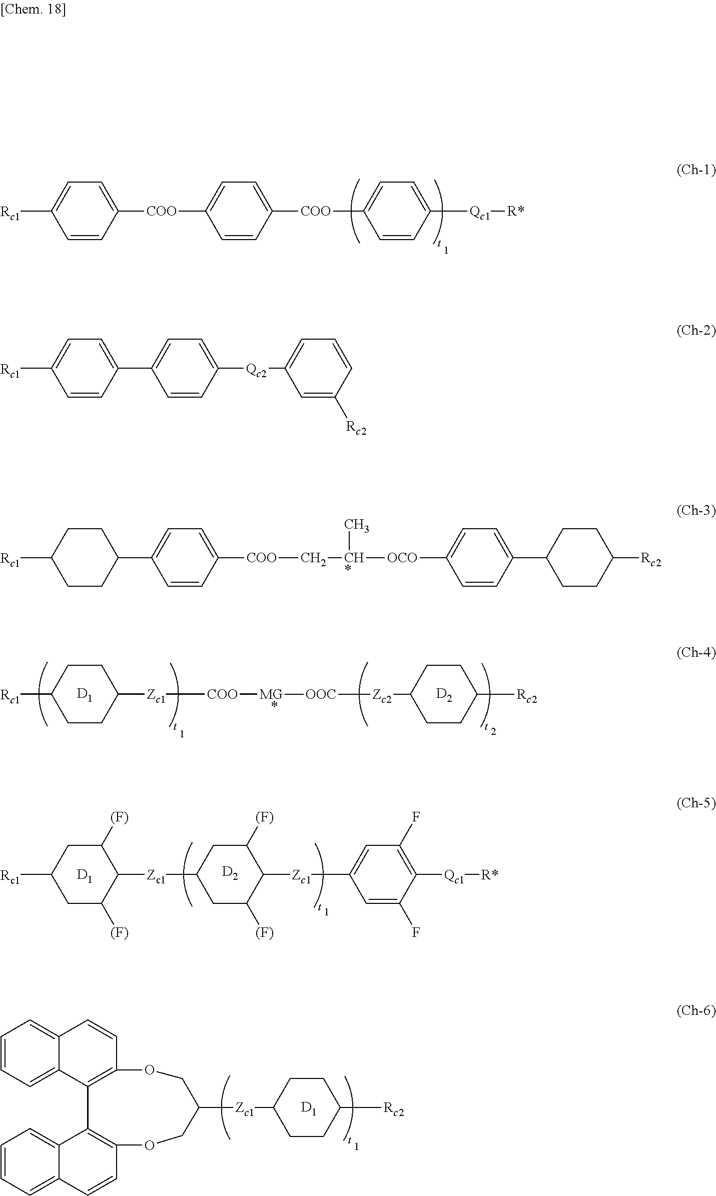

(In the formulae, R_{c1}, R_{c2}, and R* each independently represent an alkyl group having 1 to 15 carbon atoms where one or more —CH₂— in the alkyl group may each be substituted with —O—, —CH═CH—, —CO—, —OCO—, —COO—, —C≡C—, —CF₂O—, or —OCF₂— so long as oxygen atoms are not directly adjacent to each other and one or more hydrogen atoms in the alkyl group may each be substituted with a halogen; R* has at least one optically active branched group or halogen substituent; Z_{c1} and Z_{c2} each independently represent a single bond, —CH═CH—, —C≡C—, —CH₂CH₂—, —(CH₂)₄—, —COO—, —OCO—, —OCH₂—, —CH₂O—, —OCF₂—, or —CF₂O—; D₁ and D₂ each represent a cyclohexane ring or a benzene ring where one or more —CH₂— in the cyclohexane ring may each be substituted with —O— so long as oxygen atoms are not directly adjacent to each other, one or more —CH₂CH₂— in the ring may each be substituted with —CH═CH—, —CF₂O—, or —OCF₂—, one or more —CH═ in the benzene ring may each be substituted with —N═ so long as nitrogen atoms are not directly adjacent to each other, and one or more hydrogen atoms in the ring may each be substituted with F, Cl, or CH₃; t₁ and t₂ each represent 0, 1, 2, or 3; and MG*, Q_{c1}, and Q_{c2} respectively represent structures below:

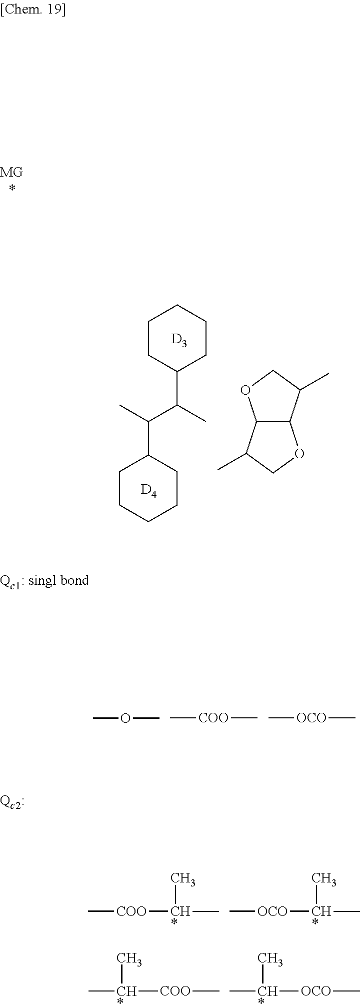

(In the formula, D₃ and D₄ each represent a cyclohexane ring or a benzene ring where one or more —CH₂— in the cyclohexane ring may each be substituted with —O— so long as oxygen atoms are not directly adjacent to each other, one or more —CH₂CH₂— in the ring may each be substituted with —CH═CH—, —CF₂O—, or —OCF₂—, one or more —CH═ in the benzene ring may each be substituted with —N═ so long as nitrogen atoms are not directly adjacent to each other, and one or more hydrogen atoms in the ring may each be substituted with F, Cl, or CH₃.)

The liquid crystal composition of the present invention may contain one or more polymerizable compounds. The polymerizable compounds are preferably discotic liquid crystal compounds having a structure in which a benzene derivative, a triphenylene derivative, a truxene derivative, a phthalocyanine derivative, or a cyclohexane derivative is at the molecular center core and linear alkyl groups, linear alkoxy groups, or substituted benzoyloxy groups radially substitute the core by forming its side chains.

To be specific, the polymerizable compound is preferably a polymerizable compound represented by general formula (PC):

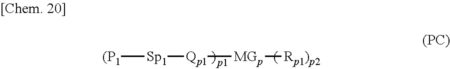

(In the formula, P₁ represents a polymerizable functional group, Sp₁ represents a spacer group having 0 to 20 carbon atoms, Qₚ₁ represents a single bond, —O—, —NH—, —NHCOO—, —OCONH—, —CH═CH—, —CO—, —COO—, —OCO—, —OCOO—, —OOCO—, —CH═CH—, —CH═CH—COO—, —OCO—CH═CH—, or —C≡C—, p₁ and p₂ each independently represent 1, 2, or 3, MGₚ represents a mesogenic group or a mesogenic supporting group, and Rₚ₁ represents a halogen atom, a cyano group, or an alkyl group having 1 to 25 carbon atoms where one or more CH₂ groups in the alkyl group may each be substituted with —O—, —S—, —NH—, —N(CH₃)—, —CO—, —COO—, —OCO—, —OCOO—, —SCO—, —COS—, or —C≡C— so long as O atoms are not directly adjacent to each other, or may represent P₂-Sp₂-Qₚ₂- where P₂, Sp₂, and Qₚ₂ are each independently the same as P₁, Sp₁, and Qₚ₁.)

More preferably, MGₚ in the polymerizable compound represented by general formula (PC) represents the following structure:

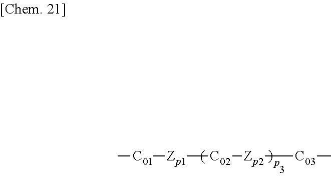

(In the formula, C₀₁ to C₀₃ each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo-(2,2,2)octylene group, a decahydronaphthalene-2,6-diyl group, a pyridine-2,5-diyl group, a pyrimidine-2,5-diyl group, a pyrazine-2,5-diyl group, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, or a fluorene-2,7-diyl group; the 1,4-phenylene group, the 1,2,3,4-tetrahydronaphthalene-2,6-diyl group, the 2,6-naphthylene group, the phenanthrene-2,7-diyl group, the 9,10-dihydrophenanthrene-2,7-diyl group, the 1,2,3,4,4a,9,10a-octahydrophenanthrene-2,7-diyl group, and the fluorene-2,7-diyl group may each have, as a substituent, at least one F, Cl, CF₃, OCF₃, cyano group, an alkyl, alkoxy, alkanoyl, or alkanoyloxy group having 1 to 8 carbon atoms, or an alkenyl, alkenyloxy, alkenoyl, or alkenoyloxy group having 2 to 8 carbon atoms; Zₚ₁ and Zₚ₂ each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, or a single bond; and p₃ represents 0, 1, or 2.)

When Sp₁ and Sp₂ each independently represent an alkylene group, the alkylene group may be substituted with one or more halogen atoms or CN, and one or more CH₂ groups in this group may each be substituted with —O—, —S—, —NH—, —N(CH₃)—, —CO—, —COO—, —OCO—, —OCOO—, —SCO—, —COS—, or —C≡C— so long as O atoms are not directly adjacent to each other. P₁ and P₂ are preferably each independently represented by any one of the following general formulae below:

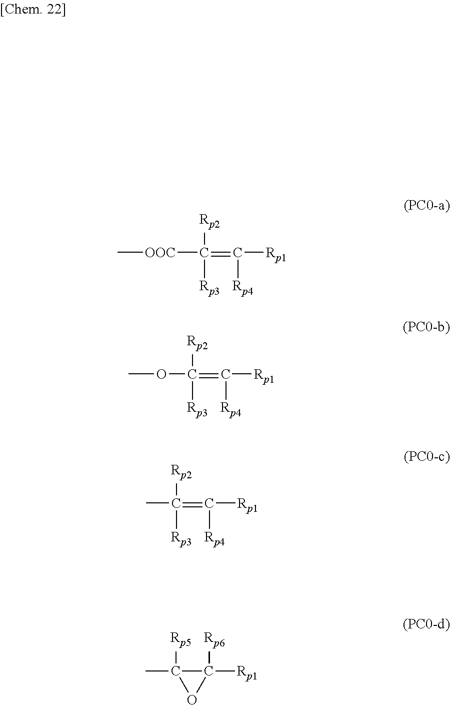

(In the formulae, Rₚ₂ to Rₚ₆ each independently represent a hydrogen atom, a halogen atom, or an alkyl group having 1 to 5 carbon atoms.)

To be more specific, polymerizable compounds represented by general formula (PC0-1) to general formula (PC0-6) are preferred as the polymerizable compound represented by general formula (PC):

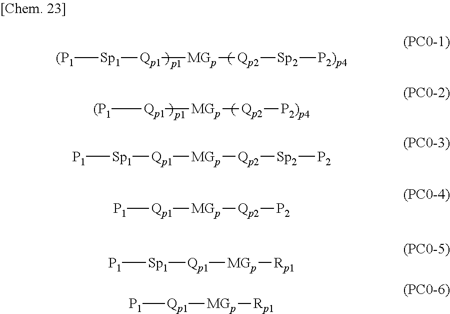

(In the formulae, p₄ each independently represent 1, 2, or 3.) More specifically, polymerizable compounds represented by general formula (PC1-1) to general formula (PC1-9) are more preferable:

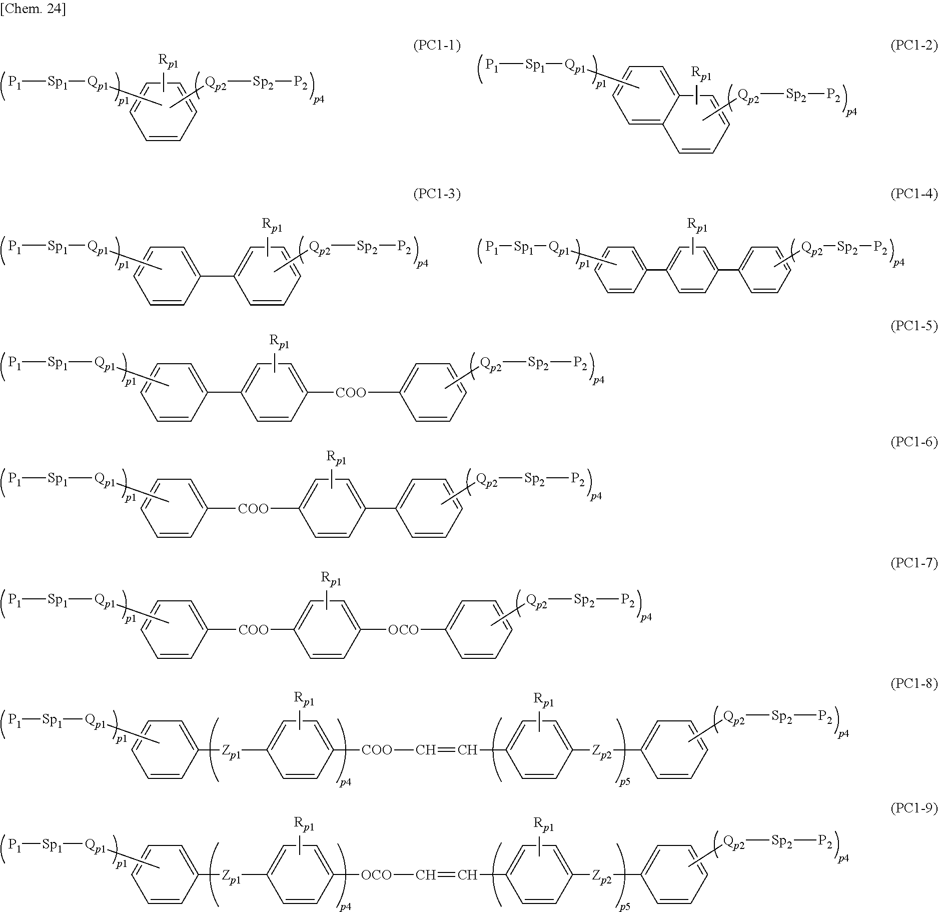

(In the formulae, p₅ represents 0, 1, 2, 3, or 4.) In these formulae, Sp₁, Sp₂, Qₚ₁, and Qₚ₂ each preferably represent a single bond, P₁ and P₂ are each preferably represented by formula (PC0-a) and more preferably are each an acryloyloxy group or a methacryloyloxy group, p₁+p₄ is preferably 2, 3, or 4, and Rₚ₁ preferably represents H, F, CF₃, OCF₃, CH₃, or OCH₃. Compounds represented by general formula (PC1-2), general formula (PC1-3), general formula (PC1-4), and general formula (PC1-8) are more preferable.

A discotic liquid crystal compound represented by general formula (PC) with MGₚ represented by general formula (PC1)-9 is also preferable.

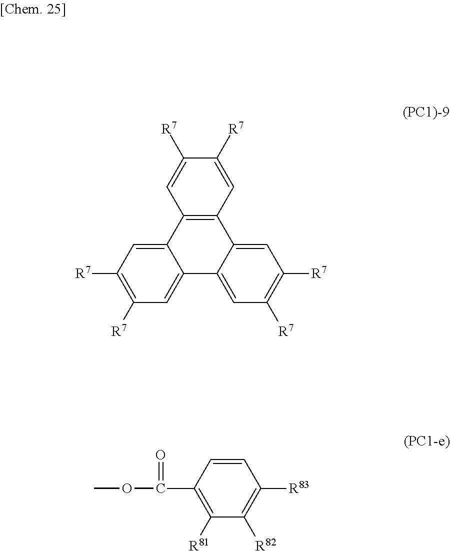

(In the formulae, R₇ each independently represent P₁-Sp₁-Qₚ₁ or a substituent represented by general formula (PC1-e), R₈₁ and R₈₂ each independently represent a hydrogen atom, a halogen atom, or a methyl group, and R₈₃ represents an alkoxy group having 1 to 20 carbon atoms where at least one hydrogen atom in the alkoxy group is substituted with a substituent represented by any of general formulae (PC0-a) to (PC0-d) described above.)

The amount of the polymerizable compounds used is preferably 0.05 to 2.0% by mass.

In order to make a liquid crystal display device from a liquid crystal composition containing a polymerizable compound according to the present invention, polymerization of the polymerizable compounds is performed. For this process, the content of the unpolymerized components is required to be decreased to a particular level or less. The liquid crystal composition preferably contains a polymerizable compound having a biphenyl group and/or a terphenyl group in a partial structure of general formula (LC0). More specifically, compounds represented by general formula (LC0-4) to general formula (LC0-6), general formula (LC0-10) to general formula (LC0-16), and general formula (LC0-27) to general formula (LC0-107) are preferable, and one or more compounds are preferably selected from these and used in an amount of 0.1 to 40% by mass. These compounds are preferably used in combination with the group consisting of polymerizable compounds represented by general formula (PC1-1) to general formula (PC1-3), general formula (PC1-8), or general formula (PC1-9).

The liquid crystal composition can also contain one or more antioxidants and one or more UV absorbers. The antioxidants are preferably selected from those represented by general formula (E-1) and/or general formula (E-2) below:

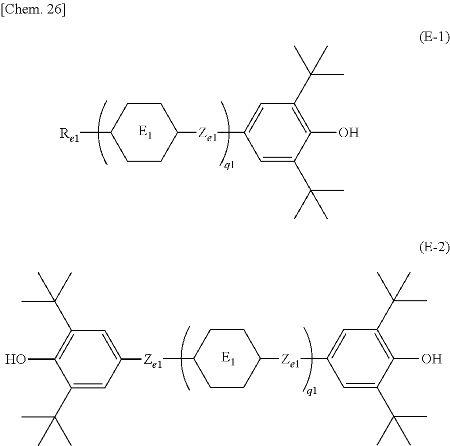

(In the formulae, Rₑ₁ represents an alkyl group having 1 to 15 carbon atoms where one or more —CH₂— in the alkyl group may each be substituted with —O—, —CH═CH—, —CO—, —OCO—, —COO—, —C≡C—, —CF₂O—, or —OCF₂— so long as oxygen atoms are not directly adjacent to each other and one or more hydrogen atoms in the alkyl group may each be substituted with a halogen,
Zₑ₁ and Zₑ₂ each independently represent a single bond, —CH═CH—, —C≡C—, —CH₂CH₂—, —(CH₂)₄—, —COO—, —OCO—, —OCH₂—, —CH₂O—, —OCF₂—, or —CF₂O—,
E₁ represents a cyclohexane ring or a benzene ring where one or more —CH₂— in the cyclohexane ring may each be substituted with —O— so long as oxygen atoms are not directly adjacent to each other, one or more —CH₂CH₂— in the ring may each be substituted with —CH═CH—, —CF₂O—, or —OCF₂—, one or more —CH═ in the benzene ring may each be substituted with —N═ so long as nitrogen atoms are not directly adjacent to each other, one or more hydrogen atoms in the ring may each be substituted with F, Cl, or CH₃, and q₁ represents 0, 1, 2, or 3.)

The liquid crystal composition of the present invention can be used in a liquid crystal display device, in particular, an active matrix driving liquid crystal display device of TN mode, OCB mode, ECB mode, IPS (including FFS electrodes) mode, or VA-IPS mode (including FFS electrodes), for example. The VA-IPS mode refers to a mode in which a liquid crystal material having positive dielectric anisotropy (Δ∈>0) is aligned perpendicular to the substrate surface in the absence of the applied voltage and liquid crystal molecules are driven by using pixel electrodes and common electrodes disposed on the same substrate surface. This mode is advantageous in that pixels can be easily divided to subareas, multi domains can be easily formed, and response is enhanced since liquid crystal molecules align in the direction of a curved electric field generated between the pixel electrodes and the common electrodes. This mode has been addressed by various names such as EOC and VA-IPS according to Non-Patent Literature Proc. 13th IDW, 97 (1997), Proc. 13th IDW, 175 (1997), SID Sym. Digest, 319 (1998), SID Sym. Digest, 838 (1998), SID Sym. Digest, 1085 (1998), SID Sym. Digest, 334 (2000), and Eurodisplay Proc., 142 (2009). In the present invention, this mode is addressed as “VA-IPS”.

Typically, the threshold voltage (Vc) of Fréedericksz transition in the TN or ECB mode is defined by equation (I):

$$[ Math . 1 ]$$

$$V c = \frac{π {d}_{cell}}{{d }_{cell + 〈 r 1 〉}} \sqrt{\frac{K 11}{Δɛ}} \qquad ( I )$$

In the STN mode, the threshold voltage (Vc) is defined by equation (II):

$$[ Math . 2 ]$$

$$V c = \frac{π {d }_{gap}}{{d }_{cell + 〈 r 2 〉}} \sqrt{\frac{K 22}{Δɛ}} \qquad ( II )$$

In the VA mode, the threshold voltage (Vc) is defined by equation (III):

$$[ Math . 3 ]$$

$$V c = \frac{π {d}_{cell} }{{d }_{cell - 〈 r 3 〉}} \sqrt{\frac{K 33}{\vert Δɛ \vert}} \qquad ( III )$$

(In the equations, Vc represents Fréedericksz transition (V), Ø represents the circular constant, d_{cell} represents the distance (μm) between a first substrate and a second substrate, d_{gap} represents the distance (μm) between pixel electrodes and common electrodes, d_{ITO} represents the width of the pixel electrodes and/or common electrodes, <r1>, <r2>, and <r3> each represent the extrapolation length (μm), K11 represents the splay elastic constant (N), K22 represents the twist elastic constant (N), K33 represents the bend elastic constant (N), and Δ∈ represents anisotropy of dielectric constant.)

The inventors of the present invention have found that expression (IV) applies to the VA-IPS mode.

$$[ Math . 4 ]$$

$$V c ∝ = \frac{{d}_{gap - 〈 r 〉} }{{d}_{ITO + 〈 r 〉}} \frac{π {d }_{cell}}{{d }_{cell - 〈 r 3 〉}} \sqrt{\frac{K 33}{\vert Δɛ \vert}} \qquad ( IV )$$

(In the expression, Vc represents Fréedericksz transition (V), Ø represents the circular constant, d_{cell} represents the distance (μm) between a first substrate and a second substrate, d_{gap} represents the distance (μm) between pixel electrodes and common electrodes, d_{ITO} represents the width of the pixel electrodes and/or common electrodes, <r>, <r′>, and <r3> each represent the extrapolation length (μm), K33 represents the bend elastic constant (N), and Δ∈ represents anisotropy of dielectric constant.) Expression (IV) shows that the cell may be designed so as to minimize d_{gap} and maximize d_{ITO} as much as possible to decrease the drive voltage. Choosing and using a liquid crystal composition that has Δ∈ having a large absolute value and a small K33 will decrease the drive voltage.

The Δ∈, K11, and K33 of the liquid crystal composition of the present invention can be adjusted to desirable values.

The product (Δn·d) of the refractive index anisotropy (Δn) of the liquid crystal composition and the distance (d) between a first substrate and a second substrate of a display device is strongly related to the viewing angle characteristics and response speed. The distance (d) thus tends to be small, e.g., 3 to 4 μm. In the TN mode, ECB mode, and IPS mode, the product (Δn·d) is preferably 0.31 to 0.33. In the VA-IPS mode where alignment is perpendicular to the two substrates, the product (Δn·d) is preferably 0.20 to 0.59 and more preferably 0.30 to 0.40. Since the optimum value of the product (Δn·d) differs depending on the mode of the display device, liquid crystal compositions that have refractive index anisotropy (Δn) in various ranges, such as 0.070 to 0.110, 0.100 to 0.140, and 0.130 to 0.180, are in demand. In order for the liquid crystal composition of the present invention to obtain a small or relatively small refractive index anisotropy (Δn), 0.1 to 80% by mass of one or more compounds selected from the group consisting of compounds represented by general formula (LC0-1) to general formula (LC0-3), general formula (LC0-7) to general formula (LC0-9), and general formula (LC0-20) to general formula (LC0-30) are preferably contained. In order to obtain large or relatively large refractive index anisotropy (Δn), 0.1 to 60% by mass of one or more compounds selected from the group consisting of compounds represented by general formula (LC0-4) to general formula (LC0-6), general formula (LC0-10) to general formula (LC0-16), and general formula (LC0-27) to general formula (LC0-107) are preferably contained.

In the TN mode or ECB mode that requires liquid crystals to align substantially horizontally with respect to the substrate surface in the absence of applied voltage, the tilt angle is preferably 0.5 to 7°. In the VA-IP mode that requires liquid crystals to align substantially vertically with respect to the substrate surface in the absence of applied voltage, the tilt angle is preferably 85 to 900. In order to align the liquid crystal composition as such, alignment films composed of polyimide (PI), polyamide, chalcone, cinnamate, cinnamoyl, or the like may be provided. The alignment films are preferably formed by an optical alignment technology. A liquid crystal composition of the present invention that contains a compound represented by general formula (LC0) with X⁰¹ representing F easily aligns along the easy axis of the alignment films and thus the tilt angle can be easily controlled to a desired angle.

The liquid crystal composition of the present invention that contains a compound represented by general formula (PC) as a polymerizable compound can be used to produce a polymer-stabilized, TN, OCB, ECB, IPS, or VA-IPS mode liquid crystal display device prepared by polymerizing the polymerizable compound in the liquid crystal composition in the presence or absence of applied voltage.

### EXAMPLES

The invention of the subject application will now be described in further detail through examples which do not limit the scope of the invention of the subject application. For the compositions of Examples and Comparative Examples below, “%” means “% by mass”.

The physical properties of the liquid crystal composition are as follows:

T_{N-I}: nematic phase-isotropic liquid phase transition temperature (° C.)
T-n: nematic phase lower limit temperature (° C.)
∈⊥: dielectric constant in a direction perpendicular to the molecular long axis at 25° C.
Δ∈: dielectric anisotropy at 25° C.
no: refractive index for ordinary rays at 25° C.
Δn: refractive index anisotropy at 25° C.
Vth: voltage (V) applied to a 6-μm thick cell at which the transmittance changed by 10% upon application of square waves at a frequency of 1 KHz at 25° C.
η₂₀: bulk viscosity (mPa·s) at 20° C.
γ₁: rotational viscosity (mPa·s)

The following abbreviations are used in the descriptions of compounds:

TABLE 1

| Abbreviation | Structure | Abbreviation | Structure |
|---|---|---|---|
| n | CₙH₂ₙ₊₁— | -OCFF- | —OCF₂— |
| m | —CₘH₂ₘ₊₁ | -V- | —CO— |
| nO | CₙH₂ₙ₊₁O— | -VO- | —COO— |
| Om | —OCₘH₂ₘ₊₁ | -OV- | —OCO— |
| ndm- | CₙH₂ₙ₊₁—CH═CH—(CH₂)ₘ₋₁— | -F | —F |
| -ndm | —(CH₂)ₙ₋₁—CH═CH—CₘH₂ₘ₊₁ | -Cl | —Cl |
| ndmO- | CₙH₂ₙ₊₁—CH═CH—(CH₂)ₘ₋₁O— | -CN | —C≡N |
| -Ondm | —O—(CH₂)ₙ₋₁—CH═CH—CₘH₂ₘ₊₁ | -CFFF | —CF₃ |
| -2- | —CH₂CH₂— | -CFF | —CHF₂ |
| -d- | —CH═CH— | -OCFFF | —OCF₃ |
| -T- | —C≡C— | -OCFF | —OCHF₂ |
| -1O- | —CH₂O— | -CFFCFFF | —CF₂CF₃ |
| -O1- | —OCH₂— | -OCF═CFF | —OCF═CF₂ |
| -CFFO- | —CF₂O— | -OCH═CFF | —OCH═CF₂ |

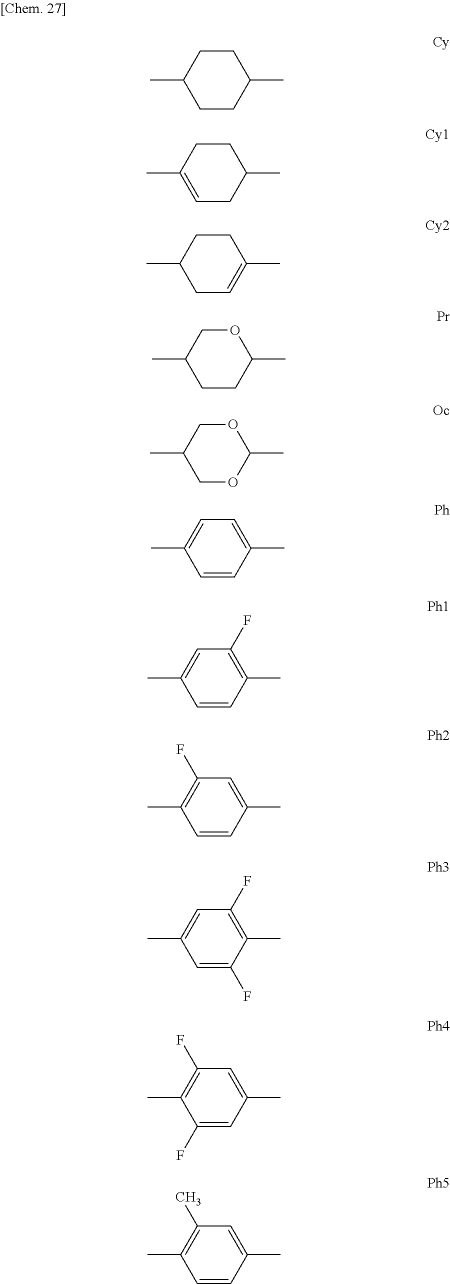

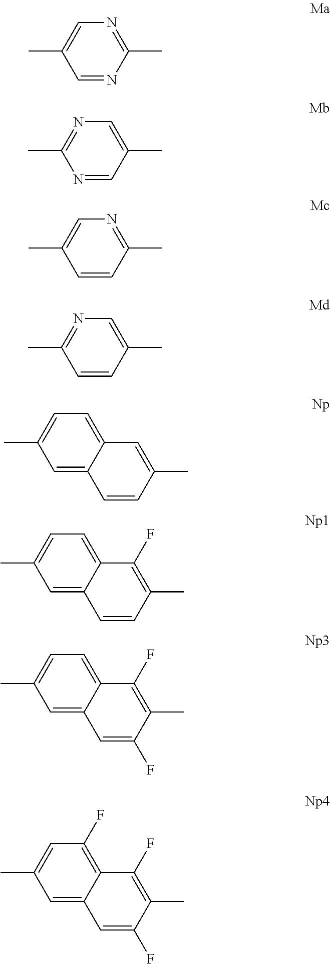

### Example 1 and Comparative Examples 1 and 2

The physical property values of a liquid crystal composition of the present invention (Example 1) prepared and liquid crystal compositions (Comp. 1) and (Comp. 2) prepared for comparison are shown below.

TABLE 2

| Compound | Example 1 | Comp. 1 | Comp. 2 |
|---|---|---|---|
| 3-Cy-Ph3-O1-Ph3-F | 5.0 | | |
| 5-Cy-Ph3-O1-Ph3-F | 5.0 | | |
| 3-Ph-Ph3-O1-Ph3-F | 5.0 | | |
| 5-Ph-Ph3-O1-Ph3-F | 5.0 | | |
| 3-Cy-Ph-O1-Ph3-F | | 5.0 | 5.0 |
| 5-Cy-Ph-O1-Ph3-F | | 5.0 | 5.0 |
| 3-Ph-Ph3-1O-Ph3-F | | 5.0 | 5.0 |
| 5-Ph-Ph3-1O-Ph3-F | | 5.0 | 5.0 |
| 3-Cy-Pr-Ph3-F | 5.0 | | 5.0 |
| 5-Cy-Pr-Ph3-F | 5.0 | | 5.0 |
| 3-Pr-Cy-Ph3-CFFO-Ph3-F | 5.0 | | 5.0 |
| 5-Pr-Cy-Ph3-CFFO-Ph3-F | 5.0 | | 5.0 |
| 3-Cy-Cy-Ph3-F | | 5.0 | |
| 5-Cy-Cy-Ph3-F | | 5.0 | |
| 3-Cy-Cy-Ph3-Ph3-F | | 5.0 | |
| 5-Cy-Cy-Ph3-Ph3-F | | 5.0 | |
| 0d1-Cy-Cy-3 | 10.0 | 10.0 | 10.0 |
| 1d1-Cy-Cy-2 | 10.0 | 10.0 | 10.0 |
| 0d3-Cy-Cy-3 | 10.0 | 10.0 | 10.0 |
| 1d1-Cy-Cy-3 | 10.0 | 10.0 | 10.0 |
| 0d1-Cy-Cy-Ph-1 | 5.0 | 5.0 | 5.0 |
| 3-Cy-Cy-Ph-1 | 5.0 | 5.0 | 5.0 |
| 1-Ph-Ph1-Ph-3d0 | 5.0 | 5.0 | 5.0 |
| 2-Ph-Ph1-Ph-3d0 | 5.0 | 5.0 | 5.0 |
| Total | 100.0 | 100.0 | 100.0 |
| Tni | 72.8 | 76.0 | 70.9 |
| T-n | −35.0 | −28.0 | −35.0 |
| Vth | 1.56 | 1.82 | 1.63 |
| Δε | 7.1 | 5.8 | 6.4 |
| Δn | 0.093 | 0.095 | 0.093 |
| η | 13.0 | 16.4 | 16.4 |
| −25° C. storage days | 21 days or | 3 days | 11 days |
| | longer\grave{ } | | |

The compositions of (Comp. 1) and (Comp. 2) do not contain a compound represented by general formula (LC0). Since the composition of (Example 1) has a far lower viscosity and a good −25° C. storage property, the composition can be used in making a liquid crystal display device having a stable nematic phase in a low temperature zone. This shows that the combination of the present invention is outstanding.

### Example 2

The liquid crystal composition prepared and the physical property values thereof are shown below.

TABLE 3

| | |
|---|---|
| 3-Pr-Cy-Ph3-F | 5.0 |
| 3-Pr-Cy-CFFO-Ph3-F | 5.0 |
| 5-Pr-Cy-CFFO-Ph3-F | 5.0 |
| 5-Pr-Di-Ph3-CFFO-Ph3-F | 5.0 |
| 3-Cy-Ph-Ph3-F | 5.0 |
| 3-Cy-Cy-CFFO-Ph3-F | 5.0 |
| 3-Cy-Ph3-O1-Ph-OCFFF | 5.0 |
| 3-Cy-Cy-Ph3-O1-Ph3-F | 5.0 |
| 3-Ph3-O1-Cy-Ph3-Ph-OCFFF | 5.0 |
| 3-Cy-Pr-Ph3-O1-Ph3-F | 5.0 |
| 1d1-Cy-Ph3-O1-Ph3-F | 5.0 |
| 0d1-Cy-Cy-3 | 10.0 |
| 1d1-Cy-Cy-2 | 10.0 |
| 0d3-Cy-Cy-3 | 10.0 |
| 3-Cy-Cy-Ph-1 | 8.0 |
| 1-Ph-Ph1-Ph-3d0 | 7.0 |
| total | 100.0 |
| Tni | 82.6 |
| T-n | −46.0 |
| Vth | 1.39 |
| Δε | 8.4 |
| Δn | 0.086 |
| η | 15.9 |

### Example 3

The liquid crystal composition prepared and the physical property values thereof are shown below.

TABLE 4

| | |
|---|---|
| 3-Pr-Ph-Ph3-F | 5.0 |
| 3-Pr-Ph1-Ph3-CFFO-Ph3-F | 5.0 |
| 3-Pr-Ph3-Ph3-CFFO-Ph1-OCFFF | 5.0 |
| 5-Pr-Di-Ph3-CFFO-Ph3-F | 5.0 |
| 3-Cy-Ph-Ph3-F | 5.0 |
| 3-Cy-Cy-CFFO-Ph3-F | |
| 3-Cy-Ph1-Ph3-CFFO-Ph3-F | 5.0 |
| 3-Ph-Ph1-Ph3-CFFO-Ph3-F | 5.0 |
| 3-Ph-Ph3-O1-Ph-OCFFF | 5.0 |
| 3-Ph-Ph1-Ph3-O1-Ph3-F | 5.0 |
| 3-Cy-Ph1-Ph3-O1-Ph-OCFFF | 5.0 |
| 3-Ph3-O1-Cy-Ph3-Ph-OCFFF | 5.0 |
| 0d1-Cy-Cy-3 | 15.0 |
| 1d1-Cy-Cy-2 | 15.0 |
| 0d3-Cy-Cy-3 | 10.0 |
| 1-Ph-Ph1-Ph-3d0 | 5.0 |
| total | 100.0 |
| Tni | 73.8 |
| T-n | −44.0 |
| Vth | 1.19 |
| Δε | 12.4 |
| Δn | 0.110 |
| η | 17.8 |

### Example 4

The liquid crystal composition prepared and the physical property values thereof are shown below.

TABLE 5

| | |
|---|---|
| 3-Pr-Cy-Ph3-F | 5.0 |
| 3-Pr-Ph-Ph3-F | 5.0 |
| 3-Pr-Cy-CFFO-Ph3-F | 5.0 |
| 5-Pr-Cy-CFFO-Ph3-F | 5.0 |
| 3-Cy-Ph-Ph3-F | 5.0 |
| 3-Cy-Cy-CFFO-Ph3-F | 5.0 |
| 3-Cy-Ph3-O1-Ph-OCFFF | 5.0 |
| 3-Ph-Ph3-O1-Ph-OCFFF | 5.0 |
| 3-Cy-Cy-Ph3-O1-Ph3-F | 5.0 |
| 3-Cy-Ph1-Ph3-O1-Ph-OCFFF | 5.0 |
| 1d1-Cy-Ph3-O1-Ph3-F | 5.0 |
| 0d1-Cy-Cy-3 | 10.0 |
| 1d1-Cy-Cy-2 | 10.0 |
| 0d3-Cy-Cy-3 | 10.0 |
| 3-Cy-Cy-Ph-1 | 8.0 |
| 1-Ph-Ph1-Ph-3d0 | 7.0 |
| total | 100.0 |
| Tni | 72.4 |
| T-n | −40.0 |
| Vth | 1.62 |
| Δε | 6.9 |
| Δn | 0.092 |
| η | 13.7 |

### Example 5

The liquid crystal composition prepared and the physical property values thereof are shown below.

TABLE 6

| | |
|---|---|
| 3-Pr-Ph1-Ph3-CFFO-Ph3-F | 5.0 |
| 3-Pr-Ph3-Ph3-CFFO-Ph1-OCFFF | 5.0 |
| 5-Pr-Di-Ph3-CFFO-Ph3-F | 5.0 |
| 3-Cy-Ph1-Ph3-CFFO-Ph3-F | 5.0 |
| 3-Ph-Ph1-Ph3-CFFO-Ph3-F | 5.0 |
| 3-Cy-Cy-Ph3-O1-Ph3-F | 5.0 |
| 3-Ph-Ph1-Ph3-O1-Ph3-F | 5.0 |
| 3-Cy-Ph1-Ph3-O1-Ph-OCFFF | 5.0 |
| 3-Ph3-O1-Cy-Ph3-Ph-OCFFF | 5.0 |
| 3-Cy-Pr-Ph3-O1-Ph3-F | 5.0 |
| 1d1-Cy-Ph3-O1-Ph3-F | 5.0 |
| 0d1-Cy-Cy-3 | 15.0 |
| 1d1-Cy-Cy-2 | 15.0 |
| 0d3-Cy-Cy-3 | 10.0 |
| 3-Cy-Cy-Ph-1 | 5.0 |
| total | 100.0 |
| Tni | 85.2 |
| T-n | −38.0 |
| Vth | 1.17 |
| Δε | 12.6 |
| Δn | 0.092 |
| η | 17.8 |

### Example 6

The liquid crystal composition prepared and the physical property values thereof are shown below.

TABLE 7

| | |
|---|---|
| 3-Pr-Ph1-Ph3-CFFO-Ph3-F | 5.0 |
| 3-Pr-Ph3-Ph3-CFFO-Ph1-OCFFF | 5.0 |
| 3-Cy-Ph1-Ph3-CFFO-Ph3-F | 5.0 |
| 3-Ph-Ph1-Ph3-CFFO-Ph3-F | 5.0 |
| 3-Cy-Ph3-O1-Ph-OCFFF | 5.0 |
| 3-Ph-Ph3-O1-Ph-OCFFF | 5.0 |
| 3-Ph-Ph1-Ph3-O1-Ph3-F | 5.0 |
| 3-Ph3-O1-Cy-Ph3-Ph-OCFFF | 5.0 |
| 3-Cy-Pr-Ph3-O1-Ph3-F | 5.0 |
| 0d1-Cy-Cy-3 | 18.0 |
| 1d1-Cy-Cy-2 | 17.0 |
| 0d3-Cy-Cy-3 | 10.0 |
| 3-Cy-Cy-Ph-1 | 5.0 |
| 1-Ph-Ph1-Ph-3d0 | 5.0 |
| total | 100.0 |
| Tni | 75.7 |
| T-n | −39.0 |
| Vth | 1.31 |
| Δε | 10.1 |
| Δn | 0.102 |
| η | 14.0 |

### Example 7

The liquid crystal composition prepared and the physical property values thereof are shown below.

TABLE 8

| | |
|---|---|
| 3-Pr-Ph-Ph3-OCFFF | 5.0 |
| 3-Pr-Cy-Ph1-Ph3-F | 5.0 |
| 2-Pr-Ph1-Ph3-CFFO-Ph3-F | 5.0 |
| 3-Pr-Ph1-Ph3-CFFO-Ph3-F | 5.0 |
| 3-Pr-Ph3-Ph3-CFFO-Ph1-OCFFF | 5.0 |
| 5-Pr-Di-Ph3-CFFO-Ph3-F | 5.0 |
| 3-Cy-Ph1-Ph3-O1-Ph3-F | 5.0 |
| 3-Cy-Ph3-O1-Ph3-Ph1-F | 5.0 |
| 3-Ph3-O1-Cy-Ph3-Ph3-F | 5.0 |
| 0d1-Cy-Cy-3 | 10.0 |
| 1d1-Cy-Cy-2 | 10.0 |
| 0d3-Cy-Cy-3 | 10.0 |
| od1-Cy-Cy-1d1 | 5.0 |
| 3-Cy-Cy-2 | 5.0 |
| 3-Cy-Ph-O2 | 5.0 |
| 3-Ph-Ph-O1 | 5.0 |
| 0d1-Cy-Cy-Ph-1 | 3.0 |
| 1-Ph-Ph1-Ph-3d0 | 2.0 |
| total | 100.0 |
| Tni | 73.2 |
| T-n | −42.0 |
| Vth | 1.23 |
| Δε | 11.8 |
| Δn | 0.094 |
| η | 16.9 |

### Example 8

The liquid crystal composition prepared and the physical property values thereof are shown below.

TABLE 9

| | |
|---|---|
| 3-Cy-Pr-Ph3-F | 5.0 |
| 3-Pr-Cy-Ph1-Ph3-F | 3.0 |
| 3-Pr-Cy-Cy-Ph3-F | 2.0 |
| 3-Pr-Cy-CFFO-Ph3-F | 5.0 |
| 3-Pr-Ph3-Ph3-CFFO-Ph1-OCFFF | 5.0 |
| 5-Pr-Di-Ph3-CFFO-Ph3-F | 5.0 |
| 3-Cy-Ph3-O1-Ph3-F | 5.0 |
| 3-Cy-Ph3-O1-Ph3-Ph1-F | 5.0 |
| 3-Ph3-O1-Cy-Ph3-Ph3-F | 5.0 |
| 3-Cy-Cy-CFFO-Np3-F | 5.0 |
| 0d1-Cy-Cy-3 | 10.0 |
| 1d1-Cy-Cy-2 | 10.0 |
| 0d3-Cy-Cy-3 | 10.0 |
| od1-Cy-Cy-1d1 | 5.0 |
| 3-Cy-Cy-2 | 5.0 |
| 3-Cy-Ph-O2 | 5.0 |
| 3-Ph-Ph-O1 | 5.0 |
| 0d1-Cy-Cy-Ph-1 | 3.0 |
| 1-Ph-Ph1-Ph-3d0 | 2.0 |
| total | 100.0 |
| Tni | 71.4 |
| T-n | −42.0 |
| Vth | 1.37 |
| Δε | 9.5 |
| Δn | 0.082 |
| η | 14.8 |

### Example 9

The liquid crystal composition prepared and the physical property values thereof are shown below.

TABLE 10

| | |
|---|---|
| 3-Cy-Pr-Ph3-F | 7.0 |
| 3-Pr-Ph-Ph3-OCFFF | 8.0 |
| 3-Pr-Cy-Ph1-Ph3-F | 8.0 |
| 3-Pr-Cy-Cy-Ph3-F | 2.0 |
| 3-Pr-Cy-CFFO-Ph3-F | 5.0 |
| 3-Cy-Ph3-O1-Ph3-F | 5.0 |
| 3-Cy-Ph1-Ph3-O1-Ph3-F | 5.0 |
| 3-Cy-Ph3-O1-Ph3-Ph1-F | 5.0 |
| 0d1-Cy-Cy-3 | 10.0 |
| 1d1-Cy-Cy-2 | 10.0 |
| 0d3-Cy-Cy-3 | 10.0 |
| od1-Cy-Cy-1d1 | 5.0 |
| 3-Cy-Cy-2 | 5.0 |
| 3-Cy-Ph-O2 | 5.0 |
| 0d1-Cy-Cy-Ph-1 | 5.0 |
| 1-Ph-Ph1-Ph-3d0 | 5.0 |
| total | 100.0 |
| Tni | 76.1 |
| T-n | −41.0 |
| Vth | 1.54 |
| Δε | 7.7 |
| Δn | 0.087 |
| η | 14.2 |

### Example 10

The liquid crystal composition prepared and the physical property values thereof are shown below.

TABLE 11

| | |
|---|---|
| 3-Cy-Pr-Ph3-F | 10.0 |
| 2-Pr-Ph1-Ph3-CFFO-Ph3-F | 5.0 |
| 3-Pr-Ph1-Ph3-CFFO-Ph3-F | 5.0 |
| 0d1-Cy-Ph1-Ph3-O1-Ph3-OCFFF | 5.0 |
| 3-Ph-Ph1-Ph3-CFFO-Ph3-F | 5.0 |
| 3-Cy-Cy-CFFO-Np3-F | 5.0 |
| 3-Ph3-O1-Ph-Np3-F(KPTN-3) | 5.0 |
| 0d1-Cy-Cy-3 | 10.0 |
| 1d1-Cy-Cy-2 | 10.0 |
| 0d3-Cy-Cy-3 | 10.0 |
| od1-Cy-Cy-1d1 | 10.0 |
| 3-Cy-Cy-2 | 5.0 |
| 3-Cy-Ph-O2 | 5.0 |
| 0d1-Cy-Cy-Ph-1 | 5.0 |
| 1-Ph-Ph1-Ph-3d0 | 5.0 |
| total | 100.0 |
| Tni | 74.4 |
| T-n | −39.0 |
| Vth | 1.44 |
| Δε | 9.0 |
| Δn | 0.099 |
| η | 14.8 |

### Example 11

The liquid crystal composition prepared and the physical property values thereof are shown below.

TABLE 12

| | |
|---|---|
| 3-Pr-Cy-Ph1-Ph3-F | 5.0 |
| 3-Pr-Cy-CFFO-Ph3-F | 5.0 |
| 3-Pr-Ph1-Ph3-CFFO-Ph3-F | 5.0 |
| 3-Pr-Ph3-Ph3-CFFO-Ph1-OCFFF | 5.0 |
| 5-Pr-Di-Ph3-CFFO-Ph3-F | 5.0 |
| 3-Cy-Ph1-Ph3-O1-Ph3-F | 5.0 |
| 3-Cy-Ph3-O1-Ph3-Ph1-F | 5.0 |
| 0d1-Cy-Ph1-Ph3-O1-Ph3-OCFFF | 5.0 |
| 3-Ph-Ph1-Ph3-CFFO-Ph3-F | 5.0 |
| 0d1-Cy-Cy-3 | 10.0 |
| 1d1-Cy-Cy-2 | 15.0 |
| 0d3-Cy-Cy-3 | 10.0 |
| od1-Cy-Cy-1d1 | 10.0 |
| 0d1-Cy-Cy-Ph-1 | 5.0 |
| 1-Ph-Ph1-Ph-3d0 | 5.0 |
| total | 100.0 |
| Tni | 87.2 |
| T-n | −40.0 |
| Vth | 1.32 |
| Δε | 11.1 |
| Δn | 0.098 |
| η | 17.2 |

### Example 12

The liquid crystal composition prepared and the physical property values thereof are shown below.

TABLE 13

| | |
|---|---|
| 3-Pr-Ph-Ph3-OCFFF | 5.0 |
| 3-Pr-Cy-Ph1-Ph3-F | 5.0 |
| 2-Pr-Ph1-Ph3-CFFO-Ph3-F | 5.0 |
| 3-Pr-Ph1-Ph3-CFFO-Ph3-F | 5.0 |
| 3-Cy-Ph1-Ph3-O1-Ph3-F | 5.0 |
| 0d1-Cy-Ph1-Ph3-O1-Ph3-OCFFF | 5.0 |
| 3-Ph-Ph1-Ph3-CFFO-Ph3-F | 5.0 |
| 3-Ph3-O1-Ph-Np3-F(KPTN-3) | 5.0 |
| 0d1-Cy-Cy-3 | 10.0 |
| 1d1-Cy-Cy-2 | 10.0 |
| 0d3-Cy-Cy-3 | 10.0 |
| od1-Cy-Cy-1d1 | 10.0 |
| 3-Ph-Ph-O1 | 5.0 |
| 0d1-Cy-Cy-Ph-1 | 7.0 |
| 1-Ph-Ph1-Ph-3d0 | 8.0 |
| total | 100.0 |
| Tni | 83.6 |
| T-n | −36.0 |
| Vth | 1.38 |
| Δε | 10.0 |
| Δn | 0.120 |
| η | 16.9 |

### Example 13

A first substrate on which a pair of comb-shape transparent electrodes was formed and a second substrate on which no electrode structures were formed were prepared. A vertical alignment film was formed on each of the substrates and an IPS empty cell in which the gap distance between the first substrate and the second substrate was 4.0 μm was formed. The liquid crystal composition of Example 12 was injected into the empty cell to prepare a liquid crystal display device. The electro-optical properties of the display device were measured. The applied voltage at which the transmittance changed by 10% was 1.42 v. The response speed under application of 5 v was 7.1 msec. The response speed measured with voltage off was 15.5 msec.

A polymerizable liquid crystal composition CLC-A was prepared by adding 1% of a polymerizable compound represented by formula (PC-1)-3-1 to 99% of the liquid crystal composition described in Example 12 to allow homogeneous dissolution:

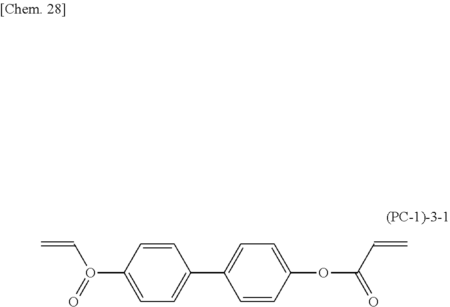

The physical properties of CLC-A were not much different from those of the liquid crystal composition described in Example 12.

After CLC-A was held in the IPS empty cell described above, the liquid crystal cell was irradiated with an UV ray from a high-pressure mercury lamp through a filter that cut UV rays of 300 nm or less while applying square waves of 1.8 V at a frequency of 1 KHz. The intensity of irradiation at the cell surface was adjusted to 20 mW/cm² and irradiation was conducted for 600 seconds so as to obtain a vertical alignment liquid crystal display device in which the polymerizable compound in the polymerizable liquid crystal composition had been polymerized. The electro-optical properties of the display device were measured. The applied voltage at which the transmittance changed by 10% was 1.48 v. The response speed under application of 5 v was 4.8 msec. The response speed measured with voltage off was 5.2 msec. This was notably faster than the liquid crystal display device prepared by using only the liquid crystal composition described in Example 12.

1-23. (canceled)

24. A liquid crystal composition having positive dielectric anisotropy, the liquid crystal composition comprising one or more compounds selected from compounds represented by general formula (LC0) and one or more compounds selected from the group of compounds represented by general formula (LC1) to general formula (LC5), wherein the liquid crystal composition comprises one or more compounds selected from the group consisting of compounds represented by general formula (LC2) with at least one of A²¹ to A²³ representing a tetrahydropyran-2,5-diyl group and compounds represented by general formula (LC3) with A³¹ representing a tetrahydropyran-2,5-diyl group: 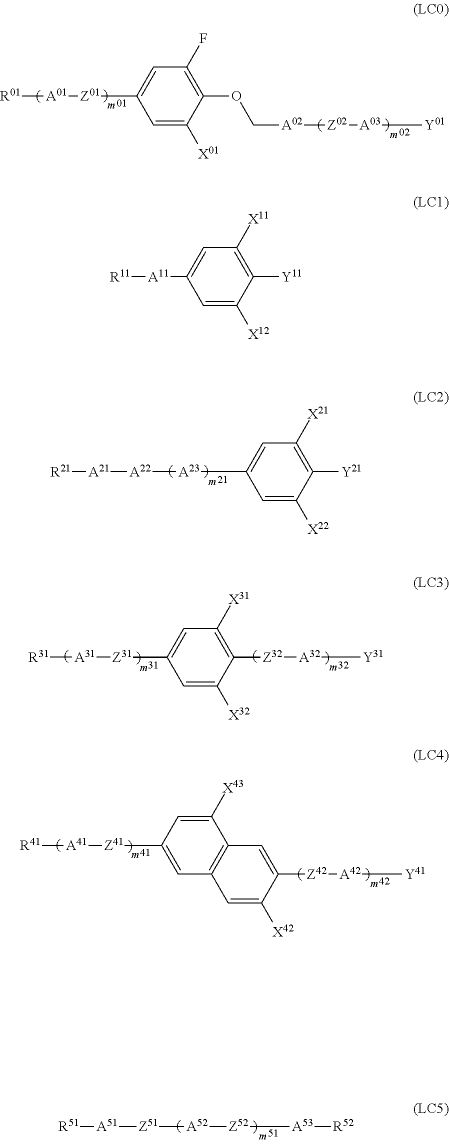
(In the formulae, R⁰¹ to R⁴¹ each independently represent an alkyl group having 1 to 15 carbon atoms where one or more —CH₂— in the alkyl group may each be substituted with —O—, —CH═CH—, —CO—, —OCO—, —COO—, —C≡C—, —CF₂O—, or —OCF₂— so long as oxygen atoms are not directly adjacent to each other and one or more hydrogen atoms in the alkyl group may each be substituted with a halogen; R⁵¹ and R⁵² each independently represent an alkyl group having 1 to 15 carbon atoms where one or more —CH₂— in the alkyl group may each be substituted with —O—, —CH═CH—, —CO—, —OCO—, —COO—, or —C≡C— so long as oxygen atoms are not directly adjacent to each other, and may each represent —OCF₃ or —CF₃ when A⁵¹ or A⁵³ described below represents a cyclohexane ring; A⁰¹ to A⁴² each independently represent any one of the following structures: 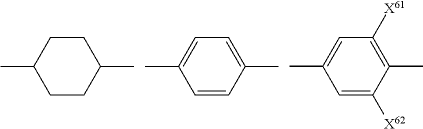
(One or more —CH₂— in a cyclohexane ring in the structure may each be substituted with —O— so long as oxygen atoms are not directly adjacent to each other, one or more —CH═ in a benzene ring in the structure may each be substituted with —N═ so long as nitrogen atoms are not directly adjacent to each other, and X⁶¹ and X⁶² each independently represent —H, —Cl, —F, —CF₃, or —OCF₃.); A⁵¹ to A⁵³ each independently represent any one of the following structures: 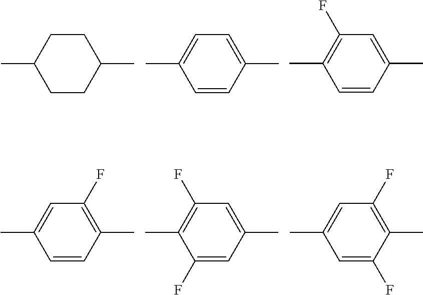
(In the formulae, one or more —CH₂CH₂— in a cyclohexane ring may each be substituted with —CH═CH—, —CF₂O—, or —OCF₂— and one or more —CH═ in a benzene ring may each be substituted with —N═ so long as nitrogen atoms are not directly adjacent to each other); X⁰¹ represents a fluorine atom; X¹¹ to X⁴³ each independently represent —H, —Cl, —F, —CF₃, or —OCF₃; Y⁰¹ to Y⁴¹ each represent —Cl, —F, —OCHF₂, —CF₃, —OCF₃, a fluorinated alkyl group having 2 to 5 carbon atoms, a fluorinated alkoxy group having 2 to 5 carbon atoms, a fluorinated alkenyl group having 2 to 5 carbon atoms, or a fluorinated alkenyloxy group having 2 to 5 carbon atoms; Z⁰¹ and Z⁰² each independently represent a single bond, —CH═CH—, —C≡C—, —CH₂CH₂—, —(CH₂)₄—, —OCF₂—, or —CF₂O—; Z³¹ to Z⁴² each independently represent a single bond, —CH═CH—, —C≡C—, —CH₂CH₂—, —(CH₂)₄—, —OCF₂—, or —CF₂O— where at least one of Z³¹ and Z³² that are present represents a group other than a single bond; Z⁵¹ and Z⁵² each independently represent a single bond, —CH═CH—, —C≡C—, —CH₂CH₂—, —(CH₂)₄—, —OCH₂—, —CH₂O—, —OCF₂—, or —CF₂O—; m⁰¹ to m⁵¹ each independently represent an integer in the range of 0 to 3, and m⁰¹+m⁰², m³¹+m³², and m⁴¹+m⁴² are each independently 1, 2, 3, or 4; and when a plurality of A⁰¹, A⁰³, A²³, A³¹, A³², A⁴¹, A⁴², A⁵², Z⁰¹, Z⁰², Z³¹, Z³², Z⁴¹, Z⁴², and/or Z⁵² are present, they may be the same or different.)

25. The liquid crystal composition according to claim 24, comprising one or more compounds represented by general formula (LC0), one or more compounds selected from the group of compounds represented by general formula (LC1) to general formula (LC4), and one or more compounds represented by general formula (LC5).

26. The liquid crystal composition according to claim 24, comprising, as the compound represented by general formula (LC2), one or more compounds selected from the group consisting of compounds represented by general formula (LC2-1) to general formula (LC2-17): 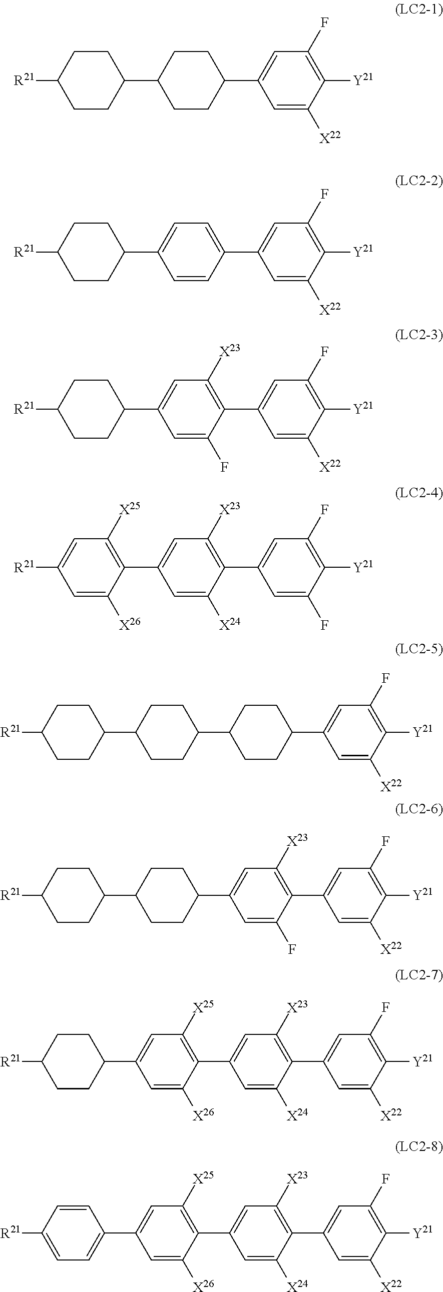 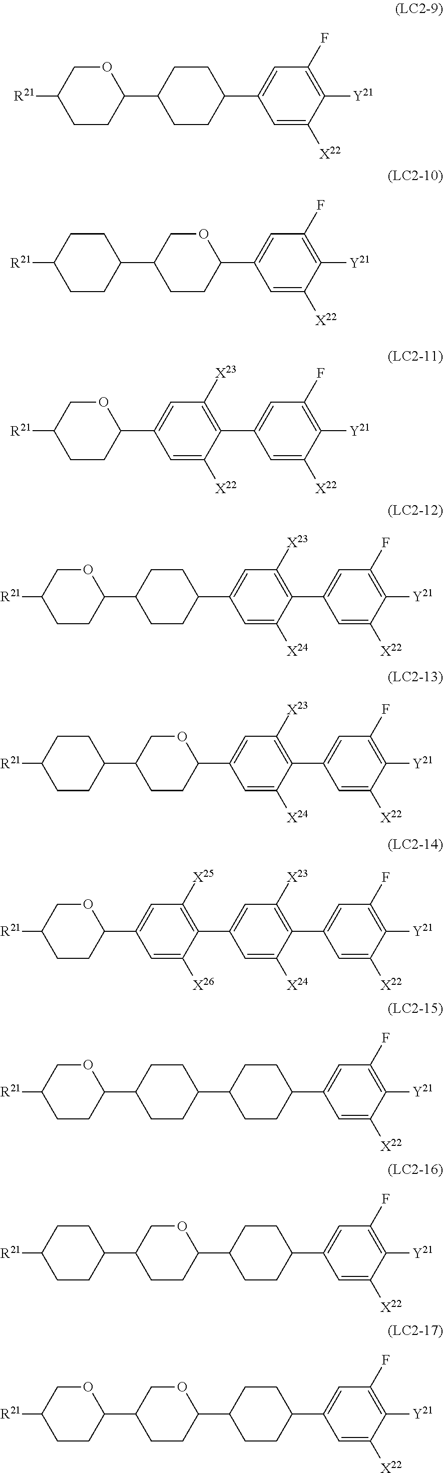
(In the formulae, X²³, X²⁴, X²⁵, and X²⁶ each independently represent a hydrogen atom, Cl, F, CF₃, or OCF₃, and X²², R²¹, and Y²¹ are the same as those in claim 24.)

27. The liquid crystal composition according to claim 24, comprising, as the compound represented by general formula (LC3), one or more compounds selected from the group consisting of compounds represented by general formula (LC3-1) to general formula (LC3-41): 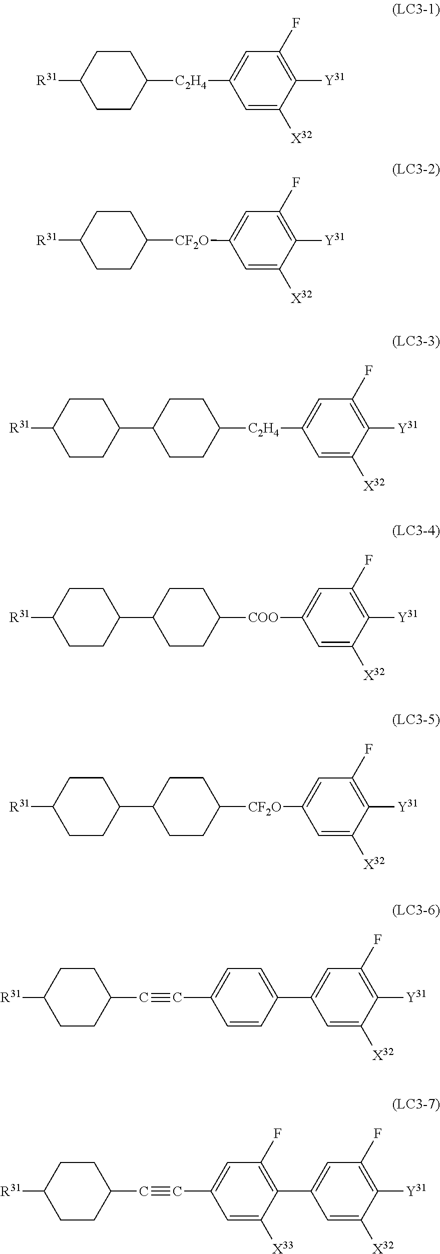 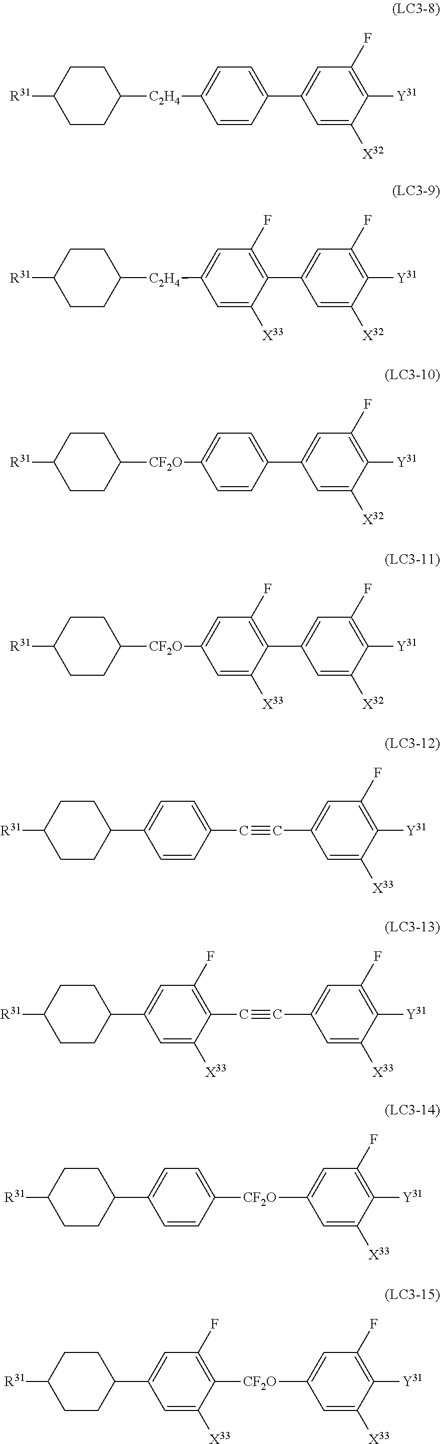 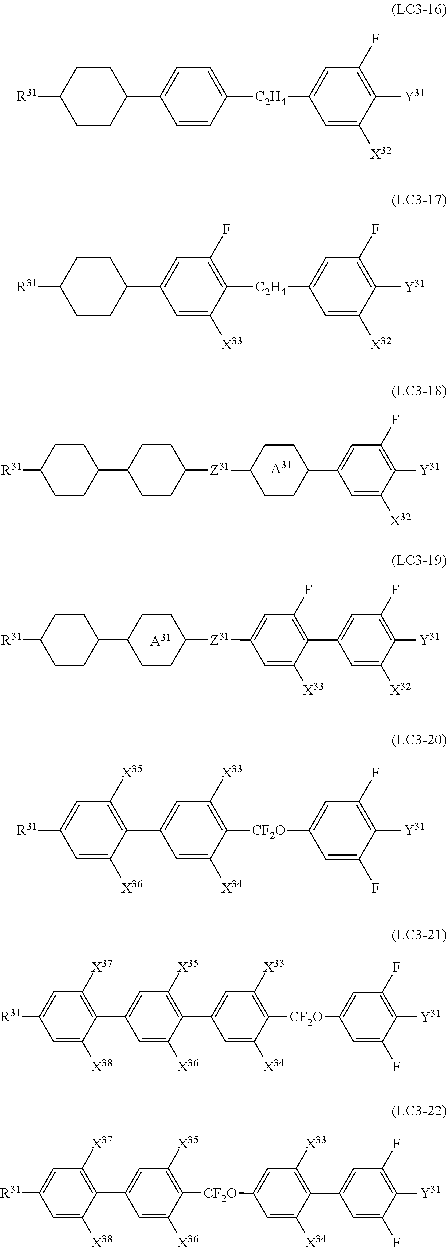 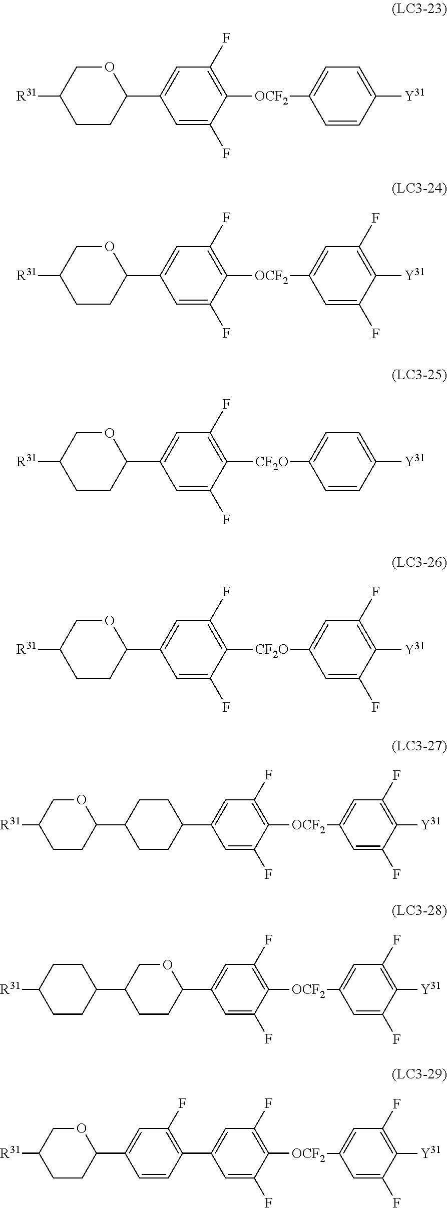 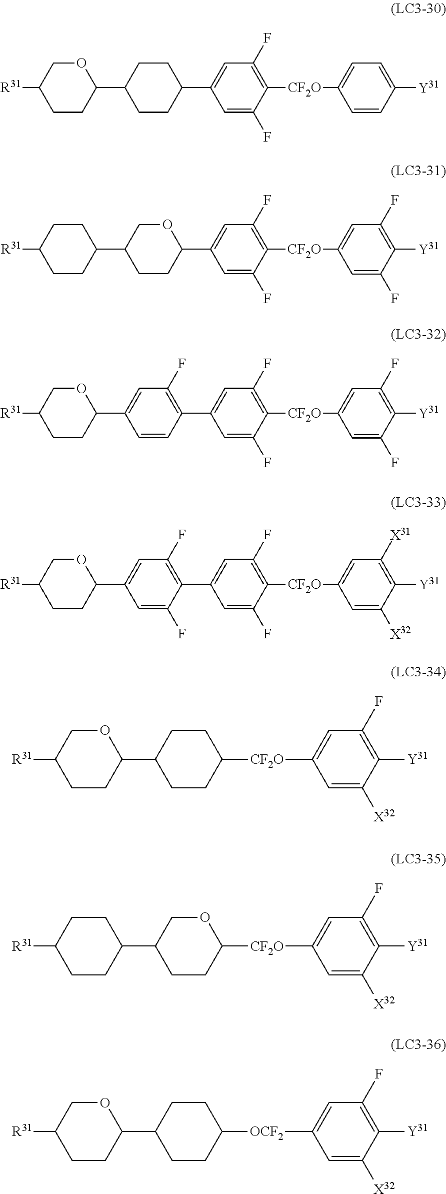 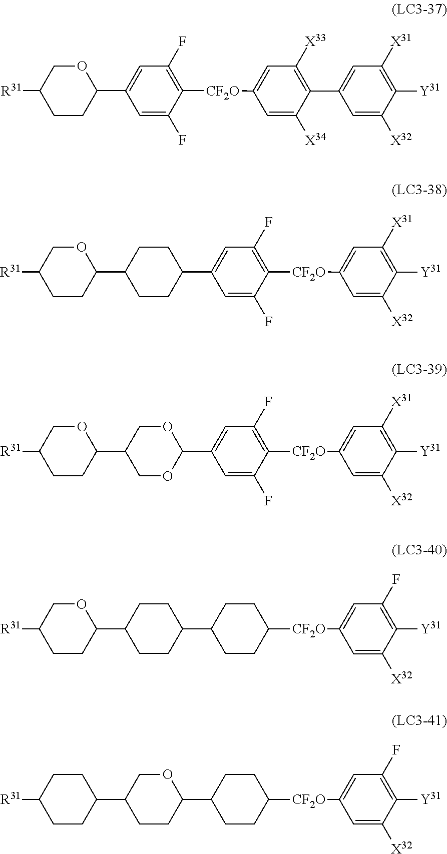
(In the formulae, X³³, X³⁴, X³⁵, X³⁶, X³⁷, and X³⁸ each independently represent H, Cl, F, CF₃, or OCF₃, and X³², R³¹, A³¹, Y³¹, and Z³¹ are the same as those in claim 24.)

28. The liquid crystal composition according to claim 24, comprising, as the compound represented by general formula (LC4), one or more compounds selected from the group consisting of compounds represented by general formula (LC4-1) to general formula (LC4-23): 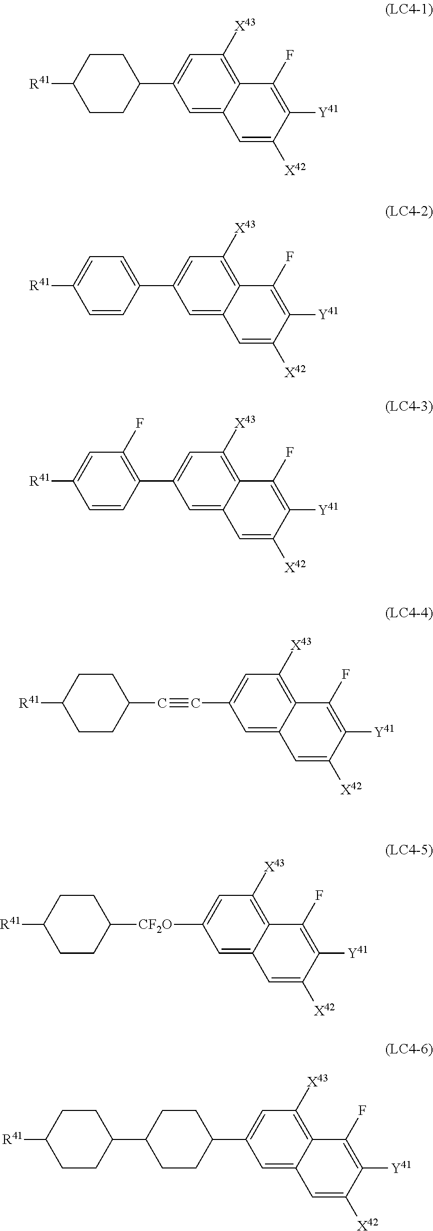 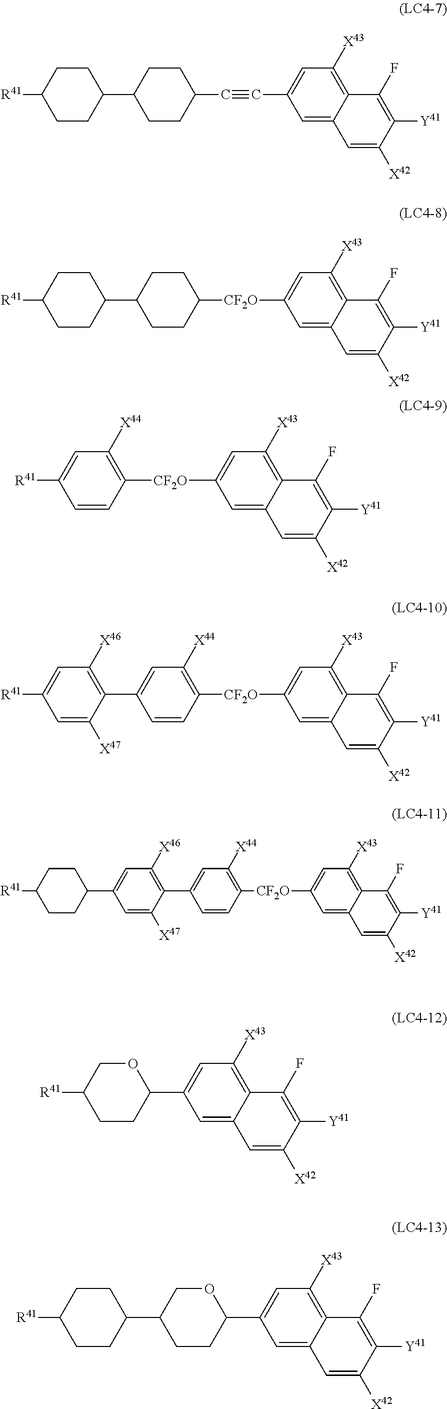 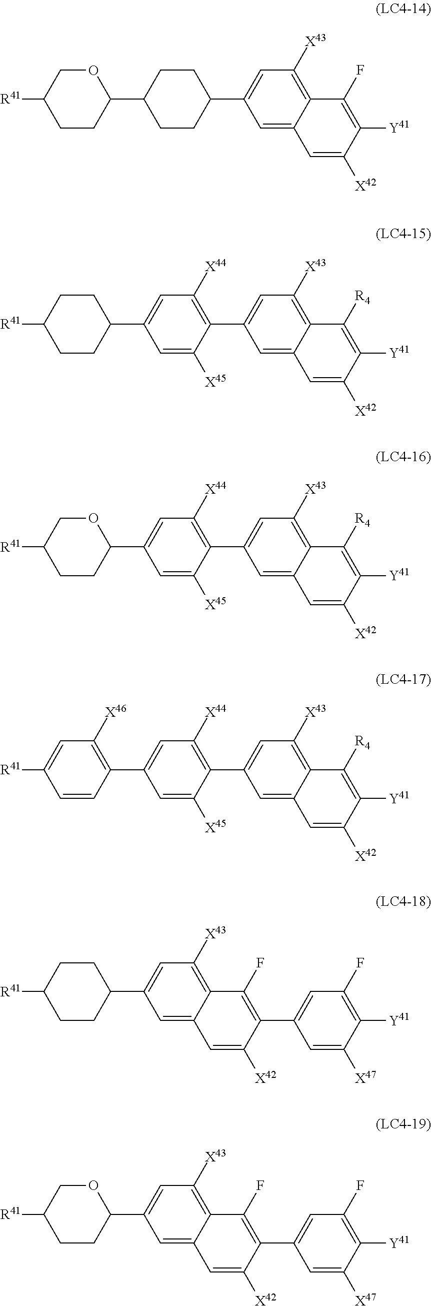 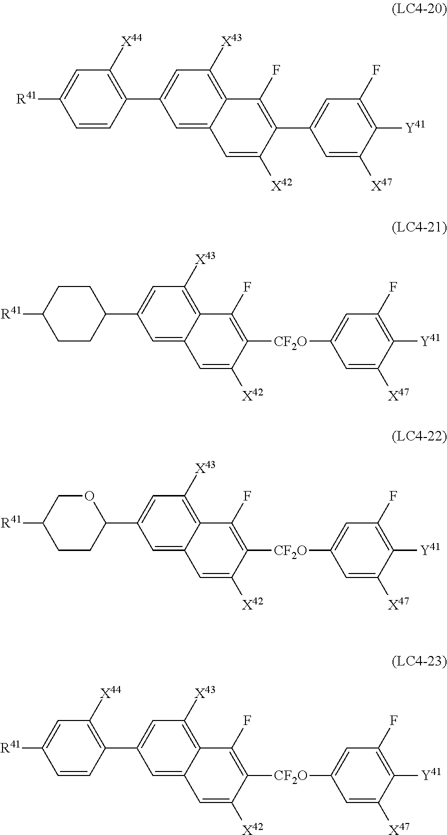
(In the formulae, X⁴⁴, X⁴⁵, X⁴⁶, and X⁴⁷ each independently represent H, Cl, F, CF₃, or OCF₃, and X⁴², X⁴³, R⁴¹, and Y⁴¹ are the same as those in claim 24.)

29. The liquid crystal composition according to claim 24, comprising, as the compound represented by general formula (LC5), one or more compounds selected from the group consisting of compounds represented by general formula (LC5-1) to general formula (LC5-26): 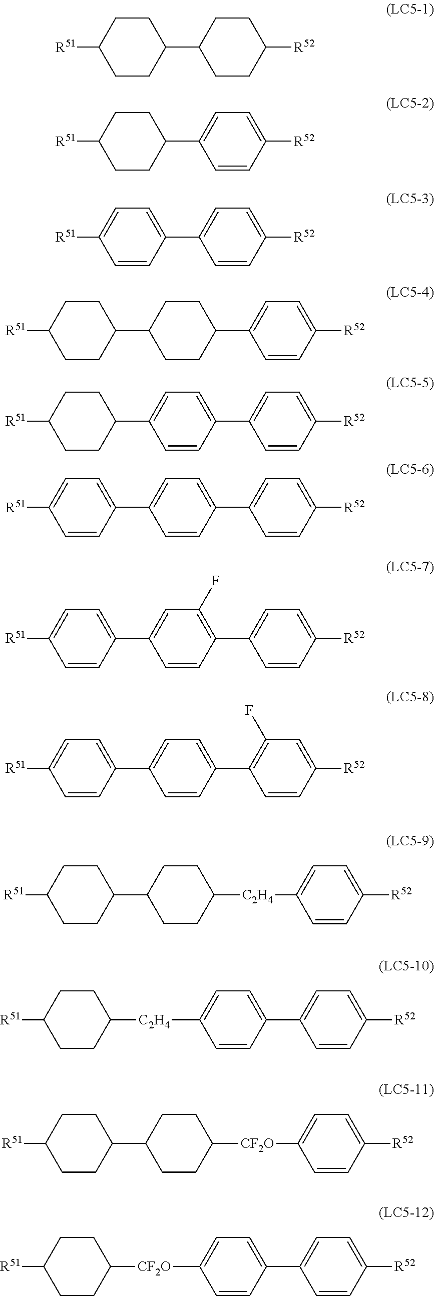 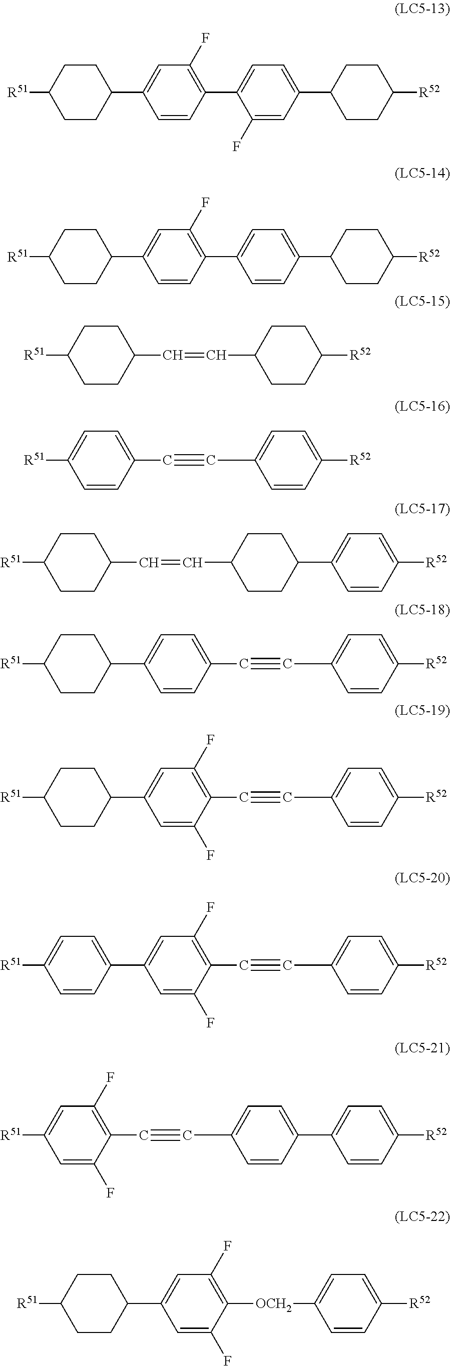 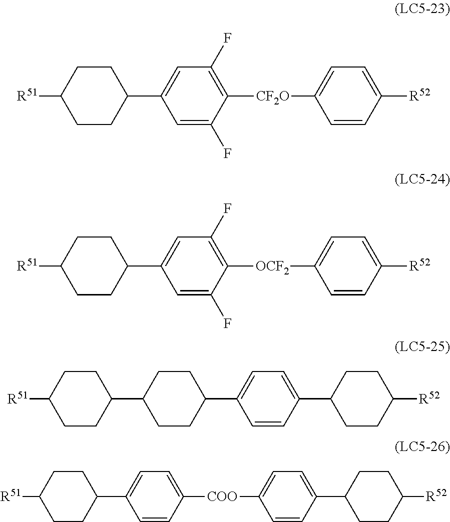
(In the formulae, R⁵¹ and R⁵² are the same as those in claim 24.)

30. The liquid crystal composition according to claim 24, comprising one or more compounds in which R⁰¹ to R⁵² in general formula (LC0) to general formula (LC5) each represent an alkenyl group having 2 to 5 carbon atoms.

31. The liquid crystal composition according to claim 24, comprising one or more compounds selected from the group consisting of compounds represented by general formula (LC0) with at least one of A⁰¹ to A⁰³ representing a tetrahydropyran-2,5-diyl group, compounds represented by general formula (LC1) with A¹¹ representing a tetrahydropyran-2,5-diyl group, compounds represented by general formula (LC4) with at least one of A⁴¹ and A⁴² representing a tetrahydropyran-2,5-diyl group, and compounds represented by general formula (LC5) with at least one of A⁵¹ to A⁵³ representing a tetrahydropyran-2,5-diyl group.

32. The liquid crystal composition according to claim 24, comprising one or more compounds selected from the group consisting of compounds represented by general formula (LC0) with at least one of Z⁰¹ and Z⁰² representing —CF₂O— or —OCF₂—, compounds represented by general formula (LC3) with at least one of Z³¹ and Z³² representing —CF₂O— or —OCF₂—, compounds represented by general formula (LC4) with at least one of Z⁴¹ and Z⁴² representing —CF₂O— or —OCF₂—, and compounds represented by general formula (LC5) with at least one of Z⁵¹ and Z⁵² representing —CF₂O— or —OCF₂—.

33. The liquid crystal composition according to claim 24, comprising 30 to 70% by mass of the compound represented by general formula (LC5) and having a viscosity η of 20 mPa·s or less at 20° C.

34. The liquid crystal composition according to claim 24, comprising one or more optically active compounds.

35. The liquid crystal composition according to claim 24, comprising one or more polymerizable compounds.

36. The liquid crystal composition according to claim 24, comprising one or more antioxidants.

37. The liquid crystal composition according to claim 24, comprising one or more UV absorbers.

38. A liquid crystal display device using the liquid crystal composition according to claim 24.

39. An active matrix driving liquid crystal display device using the liquid crystal composition according to claim 24.

40. A TN-mode, OCB-mode, ECB-mode, IPS-mode, or VA-IPS mode liquid crystal display device using the liquid crystal composition according to claim 24.

41. A polymer-stabilized TN-mode, OCB-mode, ECB-mode, IPS-mode, or VA-IPS-mode liquid crystal display device prepared by using the liquid crystal composition according to claim 35 and polymerizing the polymerizable compounds in the liquid crystal composition in the presence or absence of applied voltage.

42. The liquid crystal display device according to claim 38, wherein an alignment layer disposed at a surface in contact with liquid crystal molecules and configured to horizontally align, tilt, and/or vertically align the liquid crystal molecules is an alignment film that contains at least one compound selected from polyimide (PI), polyamide, chalcone, cinnamate, and cinnamoyl.

43. The liquid crystal display device according to claim 42, wherein the alignment layer further contains a polymerizable liquid crystal compound and/or a polymerizable non-liquid crystal compound.

44. The liquid crystal display device according to claim 42, wherein an alignment film prepared by an optical alignment technology is provided as the alignment layer at a surface in contact with the liquid crystal composition.
